(19) United States
(12) Patent Application Publication
(10) Pub. No.: US 2023/0111526 A1
(43) Pub. Date: Apr. 13, 2023

(54) COMPOSITIONS COMPRISING ALPHA, BETA-UNSATURATED ALDEHYDE AND METHODS OF USING SAME

(71) Applicant: THE STATE OF ISRAEL, MINISTRY OF AGRICULTURE & RURAL DEVELOPMENT, AGRICULTURAL RESEARCH ORGANIZATION, Rishon Lezion (IL)

(72) Inventors: David EZRA, Ein Vered (IL); Orna LIARZI, Rehovot (IL); Maayan GOLANI, Kibbutz Dvir (IL); Ariel EWENSON, Rehovot (IL); Ganit LEVI RUSO, Beer Sheva (IL)

(21) Appl. No.: 17/798,755

(22) PCT Filed: Feb. 10, 2021
(86) PCT No.: PCT/IL2021/050162

§ 371 Date: Aug. 10, 2022

Related U.S. Application Data
(60) Provisional application No. 62/972,130, filed on Feb. 10, 2020.

(51) Int. Cl. A01N 35/02; A01N 25/02; A01N 25/30

(52) U.S. Cl. CPC A01N 35/02; A01N 25/02; A01N 25/30

(57) ABSTRACT

A composition comprising a (C5-C10) α,β unsaturated aldehyde, a stabilizer and a surfactant. Further, a method of using the composition of the invention such as for reducing pest within a substrate, is provided.

### CROSS REFERENCE TO RELATED APPLICATIONS

This application claims the benefit of priority of U.S. Provisional Patent Application No. 62/972,130 filed Feb. 10, 2020, the contents of which are all incorporated herein by reference in their entirety.

### FIELD OF THE INVENTION

This invention, in some embodiments thereof, relates to the field of pesticides, and more particularly to nematocidal, herbicidal and fungicidal compounds.

### BACKGROUND

Pesticides are used for a variety of applications, including crop treatments, animal treatments, and treatments for substrates such as wood or other surfaces, and treatment of home infestations. The choice of pesticide typically depends on a variety of factors, including the type of pest, the type of application, the likelihood of contact with humans or other animals, the porosity of the substrate, and etc.

Commercially known pesticides such as herbicides, fungicides, insecticides, bactericides and other active agents and compounds are applied periodically in the home, agriculture, and other places. Farmers, however, still need to spray their crops and animals with these active agents and compounds. To this end, there have been several unsuccessful attempts to provide an efficient use of compounds in a manner that is effective, and economical, as well as environmentally acceptable.

Therefore, there is an ongoing demand for development of new pesticides and compositions comprising same, for various applications, such as for disinfection of growth medium (such as soil).

The foregoing examples of the related art and limitations related therewith are intended to be illustrative and not exclusive. Other limitations of the related art will become apparent to those of skill in the art upon a reading of the specification.

### SUMMARY

The following embodiments and aspects thereof are described and illustrated in conjunction with systems, tools and methods which are meant to be exemplary and illustrative, not limiting in scope.

In one aspect of the invention, there is provided an agricultural composition comprising an agriculturally effective amount of a pesticide, a stabilizer and a surfactant; wherein: (i) a weight ratio between the pesticide and the surfactant is between 10:1 and 1:1; (ii) a weight ratio between the pesticide and the stabilizer is between 200:1 and 10:1; (iii) the surfactant comprises a non-ionic surfactant, an anionic surfactant or both; and (iv) the pesticide comprises a (C5-C10) α,β unsaturated aldehyde.

In one embodiment, a w/w concentration of the surfactant within the composition is between 1 and 30%.

In one embodiment, the (C5-C10) α,β unsaturated aldehyde is selected from the group consisting of trans-2-octenal, trans-2-pentenal, trans-2-hexen-1-al, trans-2-nonenal, and trans-2-heptenal or any combination thereof.

In one embodiment, the non-ionic surfactant is selected from the group consisting of alkoxylated fatty acid, glucosyl dialkyl ether, polysorbate, span, tween, a polyether, a polyol, a polysaccharide, a polypeptide, a polyester, polyvinyl acetate, polyacrylamide, and polyacrylate, including any mixture or a copolymer thereof.

In one embodiment, the alkoxylated fatty acid comprises ethoxylated castor oil.

In one embodiment, the anionic surfactant is selected from the group consisting of alkyl benzene sulfonate, alcohol ether sulfate, secondary alkane sulfonates and alkyl sulfates including any combination thereof.

In one embodiment, the stabilizer is selected from the group consisting of phenol, alkyl phenol, hindered amine light stabilizer (HALS), an alkyl silane, amylene, ascorbic acid, a bisulfite salt, a metabisulfite salt, a sulfite salt, a thiol, SO₂, a hydroxide salt, a triethanolamine and dimethyl ethanolamine or any combination or a derivative thereof.

In one embodiment, the alkyl phenol is selected from the group consisting of 2,6-di-tert-butylphenol, butylated hydroxytoluene (BHT), a cresol or any combination or a derivative thereof.

In one embodiment, a w/w concentration of the stabilizer within the agricultural composition is between 0.1 and 5%, and wherein the stabilizer is BHT.

In one embodiment, the surfactant comprises polyvinyl alcohol (PVA), and wherein a w/w ratio between the pesticide and the surfactant is between 5:1 and 2:1.

In one embodiment, the surfactant comprises ethoxylated castor oil and alkyl benzene sulfonate, and wherein a w/w ratio between the pesticide and the surfactant is between 8:1 and 2:1.

In one embodiment, the agricultural composition further comprises an additive selected from the group consisting of a solvent, an anti-foaming agent, a preservative, a coloring agent, an odorizing agent or any combination thereof.

In one embodiment, the solvent comprises an aqueous solvent, a water miscible solvent or both.

In one embodiment, the water miscible solvent comprises a polar protic solvent.

In one embodiment, a weight per weight (w/w) concentration of the solvent within the composition is at least 10%.

In one embodiment, the agricultural composition is characterized by a percolation distance in a range from 1 to 60 cm within a substrate selected from the group consisting of a soil, an area under cultivation and growth medium or any combination thereof.

In another aspect, there is a method for controlling a pest or reducing growth thereof, comprising providing an effective amount of the agricultural composition of the invention; and contacting the agricultural composition with a substrate infested with the pest, thereby controlling or reducing growth of the pest.

In one embodiment, the method is controlling or reducing growth of the pest at a depth ranging from 1 to 60 cm within the substrate.

In one embodiment, the substrate is selected from the group consisting of: a soil, a plant, parts of the plant, area under cultivation and growth medium or any combination thereof.

In one embodiment, the method is for disinfecting the soil or the growth medium.

In one embodiment, the pest is a pathogenic parasite.

In one embodiment, the pest is selected from the group consisting of: nematodes, fungi, microorganisms and weed.

In one embodiment, the nematode is Meloidogyne javanica.

In one embodiment, the fungus is selected from the group consisting of: Sclerotium rolfsii, Fusarium oxysporum f. sp. radicis-lycopersici (Forl), Aspergillus niger, Botrytis cinerea, Alternaria alternata, Rhizoctonia solani, Fusarium oxysporum f. sp. radicis-cucumerinum, Lasiodiplodia theobromas, Neoscytalidium dimidiatum, Talaromyces spp., Phoma tracheiphila, Colletotrichum spp., Verticillium spp., Pythium spp., Macrophomina phaseolina and Penicillium digitatum.

In one embodiment, the effective amount comprises an amount of the pesticide of between 10 and 50,000 liter per hectare of the substrate.

In addition to the exemplary aspects and embodiments described above, further aspects and embodiments will become apparent by study of the following detailed description.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description together with the drawings makes apparent to those skilled in the art how embodiments of the invention may be practiced.

FIG. 1 represents a bar graph showing concentration (in ppm) of trans-2-octenal within a soil at a soil depth of 0, 10, 20, 25 and 30 cm.

FIG. 2 represents a bar graph showing viability of Fusarium oxysporum at a soil depth of 10, 17, and 25 cm 48 h post treatment. The soil was treated with a carrier composition containing 400 ppm of a surfactant and 400 ppm of sodium bisulfite as a negative control (left, 0), or with the fungicidal composition containing 400 ppm of a surfactant, 400 ppm of sodium bisulfite and 700 ppm of trans-2-octenal (right, 70).

FIGS. 3A-3B represent bar graphs showing viability of Sclerotium rolfsii (FIG. 3A) and Fusarium oxysporum (FIG. 3B) at a soil depth of 10, 17, and 25 cm 48 h post treatment. The soil was treated with a composition containing 700 ppm of trans-2-octenal, 0.3% w/w of ascorbic acid, and either 0.1 or 0.3% w/w of SDS.

FIG. 4 represents a bar graph showing viability of Fusarium oxysporum at a soil depth of 15 and 25 cm 4 days post treatment. The soil was treated by irrigation with exemplary compositions of the invention EW (see Table 1), EW without BHT, and EC (see Table 2).

FIG. 5 represents a bar graph showing a ratio between nematode (M. javanica) eggs to root mass upon treatment of the infected soil with an exemplary compositions of the invention EW (see Table 1) at application ratios of 20, 30 and 40 liter of trans-2-octenal per 0.1 ha soil, as compared to a non-treated control.

### DETAILED DESCRIPTION

The present invention is directed to an agricultural composition comprising a pesticide, a surfactant and optionally a stabilizer of the invention and articles comprising same.

The present invention is also directed to a method for preventing or reducing pest growth within a substrate, comprising contacting an agricultural composition described herein with the substrate, thereby preventing or reducing pest growth.

The present invention is based, in part, on the finding that compositions comprising an anionic surfactant, a non-ionic surfactant or both exhibit improved soil penetration and/or soil distribution of an α,β unsaturated aldehyde. Furthermore, some of the compositions disclosed herein exhibit a pesticidal effect (e.g. against Sclerotium rolfsii, and Fusarium oxysporum) at a soil depth of up to 25 cm upon applying to the area under cultivation. Surprisingly, a cationic surfactant (such as Cetyltrimethylammonium bromide, CTAB) based composition didn't show a significant soil penetration. Additionally, CTAB-based composition was ineffective against Sclerotium rolfsii. Furthermore, CTAB-based composition was substantially less potent with respect to Fusarium oxysporum eradication at a soil depth below 10 cm, compared to any of the compositions disclosed herein.

Moreover, the present invention is based, in part, on the finding that an antioxidant (such as sodium bisulfate or ascorbic acid) sufficiently reduces degradation (or oxidation) of the α,β unsaturated aldehyde within the soil, as confirmed by field experiments. Accordingly, by utilizing any of the compositions of the invention, the effective dosage of the pesticide (e.g. α,β unsaturated aldehyde) applied to the soil can be significantly lowered.

Thus, the present invention provides a composition for use in controlling or preventing pest growth within a substrate, particularly at a depth of 10-30 cm.

### The Composition

According to one aspect, there is provided a composition comprising a pesticide, a stabilizer and a surfactant; wherein a weight per weight (w/w) ratio between the pesticide and the stabilizer is between 200:1 and 10:1; the surfactant comprises a non-ionic surfactant, an anionic surfactant or both; and the pesticide comprises a (C5-C10) α,β unsaturated aldehyde. In some embodiments, the composition is an agricultural composition. In some embodiments, the agricultural composition is a pesticidal composition. In some embodiments, the agricultural composition of the invention optionally comprises a solvent, and/or an additive.

In some embodiments, the agricultural composition of the invention comprises a pesticide and a surfactant; wherein a weight per weight (w/w) ratio between the pesticide and the surfactant is between 10:1 and 1:1 including any range or value therebetween; the surfactant comprises a non-ionic surfactant, an anionic surfactant or both; and the pesticide comprises a (C5-C10) α,β unsaturated aldehyde.

In some embodiments, the terms “composition” or “composition of the invention” and “agricultural composition” are used herein interchangeably.

In some embodiments, a w/w ratio between the pesticide and the stabilizer is between 300:1 and 10:1. In some embodiments, a w/w ratio between the pesticide and the stabilizer is between 300:1 and 250:1, between 300:1 and 10:1, between 200:1 and 150:1, between 150:1 and 100:1, between 100:1 and 80:1, between 80:1 and 60:1, between 50:1 and 30:1, between 30:1 and 10:1, between 10:1 and 1:1, including any range or value therebetween. In a preferred embodiment, a w/w ratio between the pesticide and the stabilizer within the agricultural composition of the invention is between 250:1 and 200:1, between 200:1 and 100:1, between 100:1 and 80:1, including any range or value therebetween.

In some embodiments, a w/w ratio between the pesticide and the stabilizer is sufficient for prolonging and/or enhancing the pesticidal activity of the pesticide in the area under cultivation (e.g. soil), wherein prolonging or enhancing is as described herein. In some embodiments, a w/w concentration of the stabilizer within the agricultural composition of the invention is sufficient for prolonging and/or enhancing the pesticidal activity of the pesticide in the area under cultivation (e.g. soil), wherein prolonging and/or enhancing is as described herein. In some embodiments, a w/w concentration of the stabilizer within the agricultural composition of the invention is sufficient for reducing or preventing chemical degradation and/or decomposition of the pesticide within the area under cultivation (e.g. soil). In some embodiments, a w/w concentration of the stabilizer within the agricultural composition of the invention is sufficient for prolonging and/or enhancing chemical stability of the pesticide.

The pesticide of the invention is referred to as “stable” if at least 50%, at least 60%, at least 70%, at least 80%, at least 90%, at least 93%, at least 95% by weight of the pesticide remains stable (e.g. biologically and/or chemically intact), including any range or value therebetween. In some embodiments, at least at least 30%, at least 40%, at least 50%, at least 60%, at least 70%, at least 80%, at least 90%, at least 93%, at least 95% by weight of the pesticide remains stable (e.g. biologically and/or chemically intact) within a time period of between 1 h and 60 days including any range or value therebetween, when applying the agricultural composition to area under cultivation (e.g. soil).

As used herein, the term “prolonging” including any grammatical form thereof, refers to a time period being greater by at least 20%, at least 30%, at least 40%, at least 50%, at least 60%, at least 70%, at least 80%, at least 90%, at least 100%, at least 200%, at least 300%, at least 500%, at least 700%, at least 1000%, compared to a control including any value therebetween. In some embodiments, control comprises the same composition devoid of stabilizer.

As used herein, the term “enhancing” including any grammatical form thereof, refers to an enhancement (e.g., of the pesticide activity) by at least 20%, at least 30%, at least 40%, at least 50%, at least 60%, at least 70%, at least 80%, at least 90%, at least 100%, at least 200%, at least 300%, at least 500%, at least 700%, at least 1000%, at least 10,000%, compared to a control including any value therebetween. In some embodiments, control comprises the same composition devoid of stabilizer.

As used herein, the term “reducing”, or any grammatical derivative thereof, refers to at least 20%, 30%, 40%, 50%, 60%, 70%, 80%, 90%, or more, reduction as compared to a control. In some embodiments, control refers to the same composition being devoid of the stabilizer. In some embodiments, “reducing” refers to at least 20%, 30%, 40%, 50%, 60%, 70%, 80%, 90%, or more, reduction of the pesticide degradation and/or decomposition, compared to the same composition being devoid of the stabilizer.

As used herein, the term “biologically intact” refers to preservation of at least 60%, at least 70%, at least 80%, at least 85%, at least 90%, at least 95% of the pesticidal activity of the pesticide of the invention including any range or value therebetween.

As used herein, the term “chemically intact” refers to preservation of at least 60%, at least 70%, at least 80%, at least 85%, at least 90%, at least 95% of the chemical composition of the pesticide of the invention. As used herein, the pesticide is referred as being chemically stable, when at least 60%, at least 70%, at least 80%, at least 85%, at least 90%, at least 95% by weight of the pesticide retain its chemical structure (e.g. being devoid of decomposition, oxidation, tautomerization, dimerization, polymerization, or any other change of the initial molecular structure of the pesticide). The terms “chemical intactness” and “chemical stability” including any grammatical forms thereof are used herein interchangeably.

In some embodiments, at least 80%, at least 90%, at least 95%, at least 97%, at least 99% including any range between, by weight of the agricultural composition of the invention (e.g. EC formulation) consists essentially of the pesticide, the stabilizer and the surfactant of the invention. In some embodiments, at least 80%, at least 90%, at least 95%, at least 97%, at least 99% including any range between, by dry weight of the agricultural composition of the invention consists essentially of the pesticide, the stabilizer and the surfactant of the invention, wherein dry weight refers to the weight of the composition devoid of a solvent (e.g. an aqueous solvent, and/or a polar organic solvent as described herein). In some embodiments, at least 80%, at least 90%, at least 95%, at least 97%, at least 99% including any range between, by weight of the active components within the agricultural composition of the invention consists essentially of the pesticide, the stabilizer and the surfactant of the invention.

In some embodiments, at least 80%, at least 90%, at least 95%, at least 97%, at least 99% including any range between, by weight of the active components within the agricultural composition of the invention consists essentially of the pesticide, the stabilizer and the surfactant of the invention, and wherein the agricultural composition (e.g. EW formulation) further comprises a sufficient amount of a solvent. In some embodiments, the active components are ingredients required for the stability and/or biological activity of the composition, wherein stability and biological activity are as described herein. In some embodiments, at least 80%, at least 90%, at least 95%, at least 97%, at least 99% including any range between, by weight of the active components within the agricultural composition of the invention consists essentially of the pesticide, the stabilizer and the surfactant of the invention, and wherein the agricultural composition further comprises a solvent and/or an additive, as described herein.

In some embodiments, the stabilizer is present within the agricultural composition at a stabilizing effective amount. In some embodiments, the stabilizer is present within the agricultural composition at an amount sufficient for maintaining the stability of the pesticide. In some embodiments, a w/w concentration of the stabilizer within the agricultural composition of the invention is sufficient for substantially preserving the pesticidal activity of the pesticide for a time period sufficient for substantially decreasing and/or eradicating a pest in the area under cultivation. In some embodiments, a w/w concentration of the stabilizer within the agricultural composition of the invention is sufficient for substantially scavenge or deactivate reactive species in the area under cultivation (e.g. a free radical, an oxidant, a reductant, an enzyme, any other reactive specie, or a combination thereof). In some embodiments, a w/w concentration of the stabilizer is sufficient for reducing or preventing oxidative and/or radical damage to the pesticide, and/or to any one of the components of the agricultural composition of the invention.

In some embodiments, the term “effective amount” as used herein throughout the specification, refers to a minimum required amount.

In some embodiments, a w/w concentration of the stabilizer within the agricultural composition of the invention is sufficient for preventing or reducing degradation and/or inactivation of the pesticide in the area under cultivation. In some embodiments, degradation and/or inactivation of the pesticide is induced or enhanced by any one of the soil, ambient conditions (e.g. radicals, oxidation, UV radiation, pH, chemical composition of the soil), soil microbiome, rhizosphere, or any combination thereof.

In some embodiments, the stabilizer is any compound which prolongs the stability (e.g. chemical stability) of the pesticide in an aqueous solution or in contact with a substrate, wherein the substrate is as described hereinbelow. In some embodiments, the stabilizer increases the half-life of the pesticide. In some embodiments, the stabilizer is any compound which prolongs the stability of the pesticide for at least 20%, at least 30%, at least 40%, at least 50%, at least 60%, at least 70%, at least 80%, at least 90%, at least 100%, at least 200%, at least 300%, at least 500%, at least 700%, at least 1000% compared to a control, including any value therebetween. As exemplified hereinbelow, a composition being devoid of the stabilizer exhibited significantly lower biological activity (e.g. fungicidal activity).

In some embodiments, the stabilizer substantially prevents or reduces decomposition or degradation of the pesticide (such as due to oxidation or polymerization of the pesticide of the invention e.g. the α,β unsaturated aldehyde). In some embodiments, the stabilizer substantially prevents or reduces oxidation of the pesticide.

In some embodiments, the stabilizer is an antioxidant. In some embodiments, the stabilizer is a radical scavenger.

Non-limiting examples of antioxidants include, but are not limited to ascorbic acid, a bisulfite salt, a metabisulfite salt, a sulfite salt, and SO₂ or any combination thereof.

In some embodiments, the stabilizer is or comprises any of phenol, alkyl phenol, hindered amine light stabilizer (HALS), an alkyl silane, amylene, ascorbic acid, a bisulfite salt, a metabisulfite salt, a sulfite salt, a thiol, SO₂, a hydroxide salt, a triethanolamine and dimethyl ethanolamine including any combination, a salt, a hydrate, an isomer, a tautomer or any other derivative thereof.

In some embodiments, the stabilizer comprises one of: ascorbic acid and/or a salt thereof, a bisulfite salt, a metabisulfite salt, and a sulfite salt or a combination thereof. In some embodiments, any of bisulfite salt, metabisulfite salt, and sulfite salt comprises a counter cation. In some embodiments, the counter cation is an agriculturally acceptable cation (e.g. alkali metal cation).

In some embodiments, the stabilizer is a base.

Non-limiting examples of bases include but are not limited to: a hydroxide salt (such as alkali metal hydroxide), a tertiary amine (such as triethylamine and trimethylamine), a triethanolamine and dimethylethanolamine or any combination thereof.

In some embodiments, the stabilizer comprises a radical scavenger. Various radical scavengers are well-known in the art.

In some embodiments, the stabilizer is or comprises any of phenol, dihydroxybenzene (e.g. hydroquinone or any structural isomer, tautomer, and/or a derivative thereof) and alkyl phenol, including any combination, a salt, a hydrate, an isomer, a tautomer or any other derivative thereof. In some embodiments, the stabilizer is or comprises an alkyl phenol. In some embodiments, the stabilizer is a single compound. In some embodiments, the stabilizer comprises a plurality of stabilizers, as described herein. In some embodiments, the stabilizer of the invention consists essentially of one or more stabilizer(s), wherein the one or more stabilizer(s) is as described herein.

Non-limiting examples of alkyl phenols include but are not limited to: 2,6-di-tert-butylphenol, butylated hydroxytoluene (BHT), a cresol or any combination or a derivative thereof. In some embodiments, the stabilizer consists essentially of BHT including any isomer, tautomer or any derivative thereof.

In some embodiments, the pesticide comprises a primary alkyl-based trans-α,β unsaturated aldehyde. In some embodiments, the primary alkyl is a linear alkyl. In some embodiments, the primary alkyl comprises between 5 and 10, between 5 and 8, between 5 and 7 carbon atoms.

In some embodiments, the pesticide comprises (C5-C10) α,β unsaturated aldehyde. As used herein, the term α,β unsaturated aldehyde refers to a compound of Formula 1:

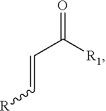

wherein R1 is selected from an alkyl, a bond or H, and wherein R is an alkyl, In some embodiments, α,β unsaturated carbonyl comprises a tautomer thereof, as represented by Formula 1A:

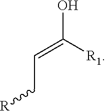

In some embodiments, the α,β unsaturated carbonyl comprises a hydrate thereof, as represented by Formula 1B:

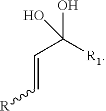

As used herein, C5-C10 refers to any alkyl (e.g. a branched alkyl, or a liner alkyl) consisting of between 5 and 10, between 5 and 6, between 5 and 7, between 7 and 8, between 8 and 9, between 9 and 10 carbon atoms, including any range between.

In some embodiments, the (C5-C10) α,β unsaturated aldehyde is or comprises trans-2-octenal, trans-2-pentenal, trans-2-hexen-1-al, trans-2-heptenal, or trans-2-nonenal or any combination thereof. In some embodiments, the pesticide comprises trans-2-octenal, trans-2-hexen-1-al, trans-2-nonenal or any combination thereof. In some embodiments, the pesticide consists essentially of trans-2-octenal including any tautomer, or any derivative thereof.

In some embodiments, the surfactant is an agriculturally acceptable surfactant. In some embodiments, a surfactant comprises a non-ionic surfactant, an anionic surfactant or both. In some embodiments, the surfactant of the invention consists essentially of a non-ionic surfactant, an anionic surfactant or both.

In some embodiments, the surfactant of the invention increases or improves spatial distribution (e.g. any of the horizontal and/or vertical dimension) of the pesticide within the soil and/or growth medium, wherein increases or improves is as described herein. In some embodiments, the surfactant of the invention is configured to increase the percolation distance of the pesticide within the soil and/or growth medium, compared to a control (e.g. the same composition with the surfactant of the invention). In some embodiments, the surfactant of the invention significantly increases the penetration depth of the pesticide into the soil and/or growth medium. In some embodiments, the surfactant of the invention is capable to induce a percolation distance of the pesticide within a growth medium (e.g. soil) to be in a range from 1 to 5 cm, from 5 to 10 cm, from 10 to 60 cm, from 5 to 60 cm, from 5 to 40 cm, from 1 to 30 cm, from 10 to 20 cm, from 10 to 25 cm, from 10 to 40 cm, from 10 to 30 cm, including any range therebetween.

In some embodiments, the surfactant of the invention is capable to induce a soil penetration of the pesticide within the soil, wherein the penetration distance is in a range of from 1 to 5 cm, from 5 to 10 cm, from 10 to 60 cm, from 5 to 60 cm, from 5 to 40 cm, from 1 to 30 cm, from 10 to 20 cm, from 10 to 25 cm, from 10 to 40 cm, from 10 to 30 cm, including any range therebetween between.

In some embodiments, the surfactant of the invention increases the penetration distance of the pesticide within the soil, so as to result in a pesticidal effective amount of the pesticide within the soil depth of at least 10 cm, at least 15 cm, at least 20 cm, at least 25 cm, at least 30 cm, at least 40 cm, at least 50 cm, at least 60 cm, including any range therebetween.

In some embodiments, the surfactant of the invention is present within the composition in an effective amount. In some embodiments, the effective amount of the surfactant within the composition is sufficient to induce or maintain pesticidal activity of the pesticide at a soil depth ranging from 1 to 5 cm, from 5 to 10 cm, from 10 to 60 cm, from 5 to 60 cm, from 5 to 40 cm, from 1 to 30 cm, from 10 to 20 cm, from 10 to 25 cm, from 10 to 40 cm, from 10 to 30 cm, including any range therebetween between.

In some embodiments, a surfactant comprises a mixture of a non-ionic surfactant, an anionic surfactant, wherein a w/w ratio of the non-ionic surfactant to the anionic surfactant is between 10:1 and 1:10, between 10:1 and 1:1, between 10:1 and 5:1, between 10:1 and 8:1, between 5:1 and 2:1, between 2:1 and 1:1, between 1:1 and 1:10, between 1:1 and 1:2, between 1:1 and 1:5, between 1:2 and 1:5, between 1:5 and 1:10, including any range or value therebetween.

The term “anionic surfactant” refers to any surfactant containing an anionic functional group including sulfate, sulfonate, phosphate, and carboxylates.

In some embodiments, the anionic surfactant of the invention is or comprises alkyl benzene sulfonate, alcohol ether sulfate, secondary alkane sulfonates and alkyl sulfates including any combination and/or any salt thereof.

In some embodiments, the anionic surfactant of the invention is or comprises alkylbenzenesulfonate (e.g. a linear (C5-C20) alkylbenzene sulfonates, such as sodium dodecylbenzenesulfonate), ammonium lauryl sulfate, sodium lauryl sulfate or (sodium dodecyl sulfate, SDS), sodium laureth sulfate (sodium lauryl ether sulfate or SLES), sodium myreth sulfate, dioctyl sodium sulfosuccinate (Docusate), perfluorooctanesulfonate (PFOS), perfluorobutanesulfonate, alkyl-aryl ether phosphates, alkyl ether phosphates, sodium stearate, sodium lauryl sarcosinate, perfluorononanoate, and perfluorooctanoate (PFOA or PFO), including any salt thereof. In some embodiments, the anionic surfactant is SDS.

Exemplary anionic surfactant of the invention comprises Rhodacal® Be-60 (sodium dodecylbenzenesulfonate).

The term “non-ionic surfactant” refers to any surfactant having covalently linked oxygen-containing hydrophilic groups, which are bonded to hydrophobic parent structures.

In some embodiments, the surfactant of the invention is or comprises a non-ionic surfactant. In some embodiments, the non-ionic surfactant of the invention is or comprises alkoxylated fatty acid, glucosyl dialkyl ether, polysorbate, span, tween, a polyether, a polyol, a polysaccharide, a polypeptide, a polyester, polyvinyl acetate, polyacrylamide, and polyacrylate, including any mixture or a copolymer thereof. Other non-ionic surfactants are well-known in the art. In some embodiments, the non-ionic surfactant of the invention comprises a polymeric surfactant (e.g. a dispersant). Numerous dispersants are well-known in the art. In some embodiments, alkoxylated fatty acid comprises ethoxylated castor oil.

In some embodiments, the non-ionic surfactant of the invention comprises a polymeric surfactant comprising a polyether, a polyol (e.g. polyvinyl alcohol or PVA), a polysaccharide (e.g. cellulose, alkylated cellulose, or any other cellulose derivative), a polypeptide, a polyester, polyvinyl acetate, polyacrylamide, and polyacrylate, including any mixture or a copolymer thereof.

Non-limiting examples of nonionic surfactants include, but are not limited to, polysorbate (e.g., polysorbate 20, 40, 60, and 80), ethoxylated castor oil, narrow-range ethoxylate, octaethylene glycol monododecyl ether, pentaethylene glycol monododecyl ether, nonoxynols, triton X-100, polyethoxylated tallow amine, cocamide monoethanolamine, cocamide diethanolamine, poloxamers, glycerol monostearate, glycerol monolaurate, sorbitan monolaurate, sorbitan monostearate, sorbitan tristearate, decyl glucoside, lauryl glucoside, octyl glucoside, lauryldimethylamine oxide, dimethyl sulfoxide, phosphine oxide, and others. In some embodiments, the nonionic surfactant is polysorbate 20.

In some embodiments, the non-ionic surfactant of the invention is or comprises ethoxylated castor oil.

In some embodiments, the surfactant of the invention comprises a polyether. In some embodiments, the polyether comprises an aliphatic polyglycol, also used herein as polyalkoxylate. In some embodiments, the polyether comprises polyethylene glycol (PEG), alkylated PEG, polypropylene glycol (PPG), alkylated PPG, branched PEG, branched PPG, polytetramethylene ether glycol, amino-modified polypropylene glycol, and ester-modified polypropylene glycol, or any copolymer comprising PPG and PEG blocks. Other polyethers include inter alia modified C5-C18 fatty alcohol ethoxylates, C10-C18 oxo alcohol ethoxylates, C16-18 unsaturated fatty alcohol ethoxylates, Sorbitan ester ethoxylates, castor oil ethoxylates or any combination thereof, Exemplary polyalkoxylate based surfactants are well-known in the art and include inter alia Agnique® Disponil®, Emulan®, Eumulgin®, Lutensol®, Synperonic®.

In some embodiments, the surfactant of the invention comprises a polyol. In some embodiments, the polyol comprises a polyalkyl backbone comprising a plurality of hydroxy groups and optionally carboxy group and/or C1-C10 carboxylate group bound thereto. In some embodiments, the polyol or polyalcohol is at least partially derived from a polysaccharide (e.g. by de-esterification). In some embodiments, the polyol comprises at least partially de-esterified or hydrolyzed polysaccharide.

In some embodiments, the polyol comprises polyester polyols (e.g. dicarbonic acids such as adipic acid, sebacic acid, itaconic acid, maleic (acid) anhydride, terephthalic acid, isophthalic acid, fumaric acid, succinic acid, oxalic acid, malonic acid, glutaric acid, pimelic acid, suberic acid, and azelaic acid; polyester polyols selected from polyol compounds such as ethylene glycol, diethylene glycol, propylene glycol, 1,4-butanediol, 1,6-hexanediol, neopentyl glycol, 1,2-propanediol, 1,3-propanediol, 1,9-nonanediol, 3-methyl-1,5-pentanediol, tripropylene glycol, trimethylolpropane, and glycerol; as well as polylactone polyester polyols such as polycaprolactone polyols and (poly)β-methyl-α-valerolactone), polyolefin-based polyols (e.g. (poly)hydroxy polymer), polyolic xylene resins, polybutadiene-based polyols (e.g. polyols consisting of homopolymers having polybutadiene backbones (1,2 adducts and 1,4 adducts); polyols consisting of polybutadiene copolymers in which butadiene, and styrene and acrylonitrile are copolymerized; as well as hydrogenated analogues of these), polyether polyols, acrylic polyols, and castor-oil derivatives (e.g. refined castor oil, dehydrated castor oil, polymerized dehydrated castor oil, and castor-oil polyols).

In some embodiments, the surfactant of the invention comprises PVA (e.g. a water soluble PVA, a polymeric resin comprising PVA or any copolymer of PVA). In some embodiments, the surfactant of the invention comprises PVA, wherein the PVA is derived from polyacetate. In some embodiments, the surfactant of the invention comprises at least partially de-esterified or hydrolyzed polyacetate. In some embodiments, the PVA of the invention comprises between 70 and 90%, between 70 and 75%, between 75 and 80%, between 80 and 85%, between 85 and 90%, between 90 and 95%, between 95 and 99% by weight of the de-esterified or hydrolyzed polyvinylacetate. Exemplary PVA polymeric surfactants include but are not limited to Poval 4-88®, Poval 5-88® Poval 6-88® Poval 8-88® including any mixture thereof.

In some embodiments, the surfactant of the invention is or comprises a polymeric surfactant (e.g. PVA), wherein a weight average molecular weight of the polymeric surfactant is from 10,000 to 250,000, from 10,000 to 250,000, from 10,000 to 20,000, from 20,000 to 30,000, from 30,000 to 40,000, from 40,000 to 50,000, from 50,000 to 60,000, from 60,000 to 70,000, from 70,000 to 80,000, from 80,000 to 90,000, from 90,000 to 100,000, from 100,000 to 150,000, from 150,000 to 200,000, from 200,000 to 250,000, including any range or value therebetween.

In some embodiments, the surfactant of the invention is or comprises PVA derived from polyvinylacetate having a weight average molecular weight of the polymeric surfactant is from 10,000 to 250,000 including any range or value therebetween. In some embodiments, the surfactant of the invention is or comprises a plurality of PVA polymers, having different molecular weight and/or de-esterification degree (e.g. between 70 and 90% including any range therebetween).

In some embodiments, the effective amount of the surfactant within the composition of the invention is between 1 and 30%, between 1 and 5%, between 1 and 3%, between 3 and 5%, between 5 and 10%, between 10 and 15%, between 15 and 20, between 20 and 30%, by weight of the composition. In some embodiments, the effective amount of the surfactant as described herein refers to a combined weight content of the anionic surfactant and the non-ionic surfactant of the invention.

In some embodiments, the effective amount of the surfactant as described herein refers to a weight content of a non-ionic surfactant of the invention (e.g. polyol such as PVA). In some embodiments, the effective amount of a non-ionic surfactant (e.g. polyol such as PVA) is less than 20%, less than 15%, less than 10%, including any range between. In some embodiments, a composition comprising a concentration of PVA greater than 15%, greater than 17%, greater than 20%, greater than 25% by weight results in a highly viscous composition. In some embodiments, the highly viscous composition is characterized by an insufficient flowability, being unsuitable for further processing. An exemplary stable composition of the invention, comprising less than 20% by weight of PVA as the surfactant (see table 1 below), has been successfully prepared by the inventors. Based on the experimental results, by increasing the concentration of PVA above 20% by weight, the resulting composition was characterized by an enhanced viscosity and too low flowability, so that the resulting composition was found unsuitable for further use and/or processing.

In some embodiments, the effective amount of the stabilizer of the invention within the composition of the invention is between 0.01 and 10%, between 0.01 and 0.1%, between 0.1 and 1%, between 0.1 and 0.3%, between 0.3 and 0.5%, between 1 and 3%, between 3 and 5%, between 5 and 10% by weight, including any range or value therebetween.

In some embodiments, the effective amount of the pesticide of the invention within the composition of the invention is between 1 and 90%, between 1 and 10%, between 10 and 15%, between 15 and 20%, between 20 and 25%, between 25 and 30%, between 30 and 35%, between 35 and 40%, between 40 and 50%, between 50 and 60%, between 60 and 70%, between 70 and 75%, between 75 and 80%, between 80 and 90% by weight including any range or value therebetween.

In some embodiments, a w/w ratio between the pesticide of the invention and the surfactant of the invention within the composition of the invention is between 10:1 and 1:1, between 10:1 and 8:1, between 8:1 and 5:1, between 10:1 and 5:1, between 5:1 and 1:1, between 5:1 and 3:1, between 3:1 and 2:1, including any range or value therebetween. In some embodiments, the effective amount of the surfactant within the composition of the invention, refers to the w/w ratio between the pesticide of the invention and the surfactant of the invention as described herein.

In some embodiments, a molar ratio of the pesticide to the surfactant within the composition is between 50:1 and 1:50, between 50:1 and 1:1, between 100:1 and 50:1, between 50:1 and 40:1, between 40:1 and 30:1, between 30:1 and 25:1, between 25:1 and 20:1, between 20:1 and 15:1, between 15:1 and 10:1, between 10:1 and 5:1, between 5:1 and 1:1, between 2:1 and 1:1, between 1:1 and 1:2, between 1:2 and 1:7, between 1:7 and 1:10, between 1:10 and 1:15, between 1:15 and 1:20, between 1:20 and 1:25, between 1:25 and 1:30, between 1:30 and 1:40, between 1:40 and 1:50, including any range or value therebetween.

In some embodiments, a w/w ratio of the pesticide to the stabilizer within the composition is between 20:1 and 1:10, between 100:1 and 50:1, between 50:1 and 30:1, between 30:1 and 20:1, between 20:1 and 15:1, between 15:1 and 10:1, between 10:1 and 5:1, between 10:1 and 8:1, between 5:1 and 2:1, between 2:1 and 1:1, between 1:1 and 1:10, between 1:1 and 1:2, between 1:1 and 1:5, between 1:2 and 1:5, between 1:5 and 1:10, including any range or value therebetween. In some embodiments, the effective amount of the stabilizer and/or of the pesticide is so that a w/w ratio of the pesticide to the stabilizer within the composition is between 20:1 and 1:1, between 20:1 and 15:1, between 15:1 and 10:1, between 10:1 and 5:1, between 5:1 and 1:1, including any range or value therebetween.

In some embodiments, a w/w ratio of the surfactant to the stabilizer within the composition is between 30:1 and 10:1, between 30:1 and 25:1, between 25:1 and 20:1, between 20:1 and 15:1, between 15:1 and 10:1, between 10:1 and 1:1, between 1:1 and 1:10, between 1:1 and 1:2, between 1:1 and 1:5, between 1:2 and 1:5, between 1:5 and 1:10, including any range or value therebetween.

In some embodiments, the agricultural composition of the invention comprises the pesticide (e.g. trans-octenal), between 0.1 and 0.3% by weight of the stabilizer and between 1 and 10% by weight of the surfactant, wherein the stabilizer is or comprises an alkyl phenol (e.g., BHT), and wherein the surfactant is or comprises a polyol (e.g. PVA). In some embodiments, the agricultural composition of the invention comprises the pesticide (e.g. trans-octenal), between 0.1 and 0.3% by weight of the stabilizer and between 1 and 10% by weight of the surfactant, wherein the stabilizer is or comprises an alkyl phenol (e.g., BHT), and wherein the surfactant is or comprises a polyol (e.g. PVA) and further comprises a non-ionic surfactant (e.g. an aliphatic polyglycol, such as PEG, PPG, or a copolymer thereof; ethoxylated castor oil, or both); and wherein a w/w ratio between the non-ionic surfactant to the polyol is between 1:20 and 1:40 including any range between. In some embodiments, the agricultural composition of the invention further comprises and additive and/or a solvent as described herein. In some embodiments, the agricultural composition of the invention is in a form of an aqueous emulsion (EW), further comprising between 10 and 60% water. In some embodiments, the w/w concentration of the pesticide within the agricultural composition is between 15 and 30%, including any range between.

In some embodiments, the agricultural composition of the invention comprises the pesticide (e.g. trans-octenal), between 0.2 and 1% by weight of the stabilizer and between 5 and 20% by weight of the surfactant, wherein the stabilizer is or comprises an alkyl phenol (e.g., BHT), and wherein the surfactant is or comprises (i) a non-ionic surfactant (e.g. ethoxylated castor oil, such as Agnique® CSO-35), (ii) an anionic surfactant (e.g. alkylbenzenesulfonate, such as sodium dodecylbenzenesulfonate), or both. In some embodiments, the agricultural composition of the invention comprises the pesticide (e.g. trans-octenal), between 0.2 and 1% by weight of the stabilizer and between 5 and 20% by weight of the surfactant, wherein the stabilizer is or comprises an alkyl phenol (e.g., BHT), and wherein the surfactant is or comprises (i) a non-ionic surfactant (e.g. ethoxylated castor oil, such as Agnique® CSO-35), and (ii) an anionic surfactant (e.g. alkylbenzenesulfonate, such as sodium dodecylbenzenesulfonate), wherein a w/w ratio between non-ionic surfactant and anionic surfactant is between 2:1 and 1:2 including any range between. In some embodiments, the w/w concentration of the pesticide within the agricultural composition is between 50 and 80%, including any range between. In some embodiments, the agricultural composition of the invention is substantially devoid of a solvent. In some embodiments, the agricultural composition of the invention is substantially devoid of an aqueous solvent (also used herein as emulsifiable concentrate, or EC).

In some embodiments, the composition comprises a solvent. In some embodiments, the solvent is an aqueous solvent and/or a polar organic solvent. In some embodiments, the polar organic solvent is water miscible. In some embodiments, the solvent comprises an aqueous solvent and an additional solvent. In some embodiments, the additional solvent is a polar organic solvent.

Non-limiting examples of polar organic solvents include but are not limited to a glycol (e.g., ethylene glycol, propylene glycol, butylene glycol), diglyme, triglyme, tetraglyme, acetone, methanol, ethanol, isopropanol, butanol, pentanol, dimethyl formamide (DMF), N-methylpyrrolidone (NMP), dimethyl sulfoxide (DMSO), and acetonitrile (ACN) or any combination thereof.

In some embodiments, the w/w concentration of the additional solvent within the composition is at most 20%, at most 15%, at most 10%, at most 8%, at most 5%, at most 3%, at most 2%, at most 1%, at most 0.5%, at most 0.1%, at most 0.05%, at most 0.001%, including any range or value therebetween.

In some embodiments, the agricultural composition is in a form of an emulsion, a dispersion, or a suspension. In some embodiments, the agricultural composition is in a form of a concentrate (EC). In some embodiments, the agricultural composition is a dilutable concentrate. In some embodiments, the agricultural composition is dilutable with an aqueous solvent. In some embodiments, the agricultural composition is dilutable with an aqueous solvent, so as to result in a stable aqueous formulation (e.g. emulsion). In some embodiments, the diluted aqueous formulation is stable (devoid of phase separation and/or aggregation of the particles) for a time period of between 1 day (d) and 1 year (y), between 1 and 30d, between 30 and 100d, between 100 and 300d, between 1 and 2y, between 2 and 5y, including any range or value therebetween. In some embodiments, the diluted aqueous formulation is stable for a time period described herein upon storage at ambient conditions (e.g. a temperature of between 5 and 80° C. including any range between).

In some embodiments, the agricultural composition (e.g. a concentrated EC or EW formulation) is stable (devoid of phase separation and/or aggregation of the particles) for a time period of between 1 day (d) and 1 year (y), between 1 and 30d, between 30 and 100d, between 100 and 300d, between 1 and 2y, between 2 and 5y, including any range or value therebetween, upon storage at ambient conditions (e.g. a temperature of between −20 and 80° C. including any range between).

In some embodiments, the agricultural composition is dilutable with an aqueous solvent. In some embodiments, the agricultural composition is dilutable with an aqueous solvent, so as to result in a ready-to use formulation appropriate for application to the soil. In some embodiments, the agricultural composition is dilutable so as to result in a ready-to use formulation comprising a pesticidally effective amount of the pesticide of the invention. In some embodiments, the agricultural composition is dilutable up to between 5 and 1000 times, between 5 and 10 times, between 10 and 30 times, between 30 and 50 times, between 50 and 100 times, between 100 and 500 times, between 500 and 1000 times, between 1000 and 10,000 times, including any range or value therebetween, relative to the initial volume of the composition.

In some embodiments, the agricultural composition is a liquid. In some embodiments, the agricultural composition (e.g. EC) is substantially homogeneous. In some embodiments, the agricultural composition (e.g. EC) is substantially devoid of particulate matter. In some embodiments, the agricultural composition is substantially devoid of solid particles (e.g. devoid of a dispersion). In some embodiments, the agricultural composition is substantially inhomogeneous. In some embodiments, the agricultural composition comprises one or more liquid phases.

In some embodiments, the agricultural composition is in a form of a concentrated aqueous emulsion (EW). In some embodiments, the agricultural composition is an EW formulation comprising an oil in water (o/w) emulsion.

In some embodiments, the agricultural composition is in a form of an emulsion (e.g. EW, or a diluted composition of the invention), being characterized by an average particle size of between 0.5 and 10 um, between 0.8 and 1 um, between 1 and 2 um, between 0.8 and 2 um, between 2 and 3 um, between 3 and 5 um, between 5 and 7 um, between 5 and 10 um, between 10 and 50 um, including any range or value therebetween.

In some embodiments, the agricultural composition is in a form of an emulsion (e.g. EW, or a diluted composition of the invention) comprising plurality of micro particles (e.g. micelles). In some embodiments, the emulsion is stable, wherein stable is as described herein.

In some embodiments, the agricultural composition (e.g. EW, or a diluted composition of the invention) is in a form of an emulsion, wherein at least 50%, at least 60%, at least 70%, at least 80%, at least 85%, at least 90% of the particles within the emulsion are characterized by a particle size of less than 5 um, less than 4 um, less than 3 um, less than 2 um, including any range or value therebetween. In some embodiments, the agricultural composition is in a form of an emulsion, wherein between 80 and 95%, of the particles within the emulsion are characterized by a particle size of less than 5 um, less than 4 um, less than 3 um, less than 2 um, including any range or value therebetween. In some embodiments, at least 90% of the particles within the emulsion are characterized by a particle size of less than 2 um.

In some embodiments, the aqueous solvent comprises water, an aqueous buffer, an aqueous salt solution or any combination thereof. In some embodiments, the w/w concentration of the aqueous solvent within the composition is sufficient for the stabilization of the composition (e.g. emulsion). In some embodiments, the w/w concentration of the aqueous solvent within the (e.g. the concentrated formulation before dilution) composition is at most 80%, at most 70%, at most 60%, at most 50%, at most 40%, including any range or value therebetween.

In some embodiments, the composition is an aqueous composition. In some embodiments, a pH of the composition is from 4 to 9, from 5 to 8, from 6 to 8, from 6.5 to 7, from 7.5 to 8, including any range or value therebetween.

In some embodiments, the composition is an agricultural composition comprising an agriculturally effective amount of the pesticide, the stabilizer, the surfactant and an agriculturally acceptable carrier or solvent. In some embodiments, the composition is a pesticide composition comprising a pesticide effective amount of the pesticide, the stabilizer, the surfactant and optionally an agriculturally acceptable carrier or solvent.

In some embodiments, a weight per weight (w/w) concentration of the pesticide within the agricultural composition (e.g. a diluted aqueous composition) is between 1 ppm and 10%, between 1 and 10,000 ppm, between 1 and 100 ppm, between 10 and 100 ppm, between 100 and 200 ppm, between 200 and 400 ppm, between 400 and 500 ppm, between 500 and 600 ppm, between 600 and 700 ppm, between 700 and 800 ppm, between 650 and 750 ppm, between 800 and 1,000 ppm, between 1,000 and 2,000 ppm, between 2,000 and 4,000 ppm, between 4,000 and 6,000 ppm, between 6,000 and 8,000 ppm, between 8,000 and 10,000 ppm, between 1 and 10%, between 1 and 3%, between 3 and 5%, between 5 and 7%, between 7 and 10%, including any range or value therebetween. In some embodiments, a w/w concentration of the pesticide within the agricultural composition (e.g. a diluted aqueous composition) is between 200 and 1,000 ppm.

In some embodiments, a w/w concentration of the surfactant within the agricultural composition (e.g. diluted aqueous composition) is between 1 ppm and 10%, between 1 and 10,000 ppm, between 1 and 100 ppm, between 10 and 100 ppm, between 100 and 200 ppm, between 200 and 400 ppm, between 400 and 500 ppm, between 500 and 600 ppm, between 600 and 700 ppm, between 700 and 800 ppm, between 650 and 750 ppm, between 800 and 1,000 ppm, between 1,000 and 2,000 ppm, between 2,000 and 4,000 ppm, between 4,000 and 6,000 ppm, between 6,000 and 8,000 ppm, between 8,000 and 10,000 ppm, between 1 and 10%, between 1 and 3%, between 3 and 5%, between 5 and 7%, between 7 and 10%, including any range or value therebetween. In some embodiments, a w/w concentration of the surfactant within the agricultural composition (e.g. a diluted aqueous composition) is between 100 and 1,000 ppm. In some embodiments, a w/w concentration of the surfactant within the composition is between 0.1 and 1%, between 0.2 and 0.5%.

In some embodiments, a w/w concentration of the stabilizer within the agricultural composition (e.g. a diluted aqueous composition) is between 1 and 10,000 ppm, between 1 and 100 ppm, between 10 and 100 ppm, between 100 and 200 ppm, between 200 and 400 ppm, between 400 and 500 ppm, between 500 and 600 ppm, between 600 and 700 ppm, between 700 and 800 ppm, between 650 and 750 ppm, between 800 and 1,000 ppm, between 1,000 and 2,000 ppm, between 2,000 and 4,000 ppm, between 4,000 and 6,000 ppm, between 6,000 and 8,000 ppm, between 8,000 and 10,000 ppm, between 1 and 10%, between 1 and 3%, between 3 and 5%, between 5 and 7%, between 7 and 10%, including any range or value therebetween.

In some embodiments, a w/w concentration of the stabilizer within the agricultural composition (e.g. a diluted aqueous composition) is between 100 and 1,000 ppm. In some embodiments, a w/w concentration of the surfactant within the composition is between 0.1 and 1%, between 0.2 and 0.7%.

In some embodiments, the effective amount of the pesticide of the invention within the agricultural composition of the invention is so that a volume ratio of the pesticide applied to the soil is at least 200 l/hectare, at least 300 l/hectare, at least 400 l/hectare, including any range between. In some embodiments, the effective amount of the pesticide of the invention within the agricultural composition of the invention is so that a volume ratio of the pesticide applied to the soil is at least 10 l/hectare, at least 20 l/hectare at least 50 l/hectare, at least 100 l/hectare, at least 200 l/hectare, at least 300 l/hectare, including any range between.

In some embodiments, the effective amount of the pesticide of the invention within the agricultural composition of the invention is so that a volume ratio of the pesticide applied to the soil is between 10 and 1000 l/hectare, between 10 and 100 l/hectare, between 100 and 200 l/hectare, between 100 and 200 l/hectare, between 200 and 300 l/hectare, between 300 and 400 l/hectare, between 400 and 500 l/hectare, including any range between.

In some embodiments, the effective amount of the pesticide of the invention is sufficient for significant reduction and/or eradication of the pest load at the area under cultivation (e.g. soil). As used herein, the term “significant reduction” refers to at least 80%, at least 85%, at least 90%, at least 95%, at least 97%, at least 99%, at least 99.9%, reduction of the pest load including any range between.

In some embodiments, the effective amount of the pesticide of the invention sufficient for pest (a fungi or a nematode) eradication is at least 300 l/hectare, at least 310 l/hectare, at least 320 l/hectare, at least 330 l/hectare, at least 350 l/hectare, at least 370 l/hectare, at least 380 l/hectare, at least 390 l/hectare, at least 400 l/hectare, including any range between.

The disclosed compositions set forth above may be formulated in any manner. Non-limiting formulation examples include but are not limited to Emulsifiable concentrates (EC), Wettable powders (WP), Soluble liquids (SL), Solid formulations (e.g. Granules), Aerosols, Ultra-low volume concentrate solutions (ULV), Soluble powders (SP), Microencapsulation, Water dispersed granules (WDG), Flowable (FL), Micro emulsions (ME), Nano-emulsions (NE), etc. In any formulation described herein, percent of the active ingredient is well within the skills of the artisan e.g., within a range of 0.01% to 99.99%.

In some embodiments, the composition of the invention comprises a solid formulation, comprising a solid carrier, the stabilizer of the invention and the pesticide of the invention, wherein a w/w ratio between the stabilizer and the solid carrier is between 200:1 and 50:1, including any range between. In some embodiments, the solid carrier (or filler) is or comprises at least partially degradable or erodible carrier. In some embodiments, the composition of the invention (e.g. a solid formulation) comprises between 1 and 50%, between 1 and 10%, between 10 and 20%, between 20 and 30%, between 30 and 50%, by weight of the pesticide of the invention, including any range between.

In some embodiments, the solid formulation is substantially devoid of the surfactant.

Non-limiting examples of solid carriers include but are not limited to: cellulose, including any cellulose derivatives (e.g. alkylated cellulose, cellulose esters, etc.), mineral carriers (e.g. kaolin clay, pyrophyllite, bentonite, montmorillonite, diatomaceous earth, acid white soil, vermiculite, pearlite, loam, and silica), inorganic salts (e.g. ammonium sulfate, ammonium phosphate, ammonium nitrate, urea, ammonium chloride, and calcium carbonate), alginate, vermiculite, seed cases, other plant and animal products, or any combination thereof.

In some embodiments, the solid carrier is or comprises a cellulosic granule. Such granule are well-known in the art. Preferred carrier granules used in the compositions of the present invention are agglomerated cellulosic granules sold by Kadant Grantek, Inc. of Green Bay, Wis. under its trademark BIODAC®. These and other agglomerated cellulosic granules suitable to the practice of the present invention preferably contain at least 30% by weight cellulosic fibers and more preferably contain at least about 50% by weight cellulosic fibers.

The starting material in the formation of the cellulosic granules preferably is pulp or paper sludge, although other fibrous plant materials such as vegetable fibers like sugar beet, sugar cane, citrus pulp, grain and potato, and wood flour, peat moss, composted organic materials and manures may be utilized. Other starting materials that may be included can be selected from the following non-limiting list: cotton, straw, brewers condensed solubles, lignosulfonate, sodium carbonate lignin, cane molasses, beet syrup, beet molasses, whey starch, soy solubles, corn cob, rice hulls, peanut hulls, ground wheat straw flour, wheat flour, soy flour, cellulose derivates, cellulose-based polymer binders, seed meal, feather meal, soy meal, humic acid, animal waste, activated sludge, and hydrolyzed animal hair. The starting material may also contain up to about 20% extraneous matter, such as synthetic fibers, shredded plastics and ink residues. The above materials, including pulp or paper sludge, may be used either individually or in any combination of two or more thereof.

When pulp or paper sludge is used, it may include any primary pulp or paper sludge generated by a sulfate, sulfite, de-inked, mechanical or semi-chemical pulping process either alone or in combination with a secondary sludge generated by a sulfate, sulfite, de-inked, mechanical or semichemical pulping process. Primary de-inked sludge is the waste material produced from paper mills which use waste paper both pre- and post-consumer, newsprint and other papers as feedstock. The sludge has a content of about 40%-90% fiber and about 10%-60% filler (e.g. kaolin, barytes, calcium carbonate, titanium dioxide, other plant fibers, etc.).

While the active ingredients preferably will be incorporated into the granules after they are dried, the active ingredients may also be incorporated into the sludge mixture before the granules are dried, so long as the active ingredients will retain their efficacy after being subjected to the heat associated with drying. Various methods of manufacturing of the solid composition of the invention (e.g. cellulosic granules) are well-known in the art.

In some embodiments, the composition further comprises an additive. In some embodiments, a w/w concentration of the additive within the composition is in a range between 0.001 and 50%. In some embodiments, the additive comprises any of a plant nutrient, a fertilizer, a sticking agent, a buffer, a defoaming agent, a biocide, a thickener, or any combination thereof. Various commercial additives are well-known in the art, some of them have been utilized in exemplary compositions of the invention, as exemplified in Table 1 and 2 below.

In some embodiments, a w/w concentration of the additive within the formulation or the herbicidal composition is from 0.001% to 10%, from 0.01% to 0.1%, from 0.1% to 0.5%, from 0.5% to 1%, from 0.1% to 0.3%, from 0.3% to 0.5%, from 0.5% to 0.7%, from 0.7% to 1%, from 1% to 1.5%, from 1.5% to 2%, from 2% to 2.5%, from 2.5% to 3%, from 3% to 3.5%, from 3.5% to 4%, from 4% to 5%, from 5% to 6%, from 6% to 7%, from 7% to 8%, from 8% to 10% including any range or value therebetween.

In some embodiments, the formulation comprises a tackifier or adherent. Such agents are useful for combining the compound of the invention with carriers to yield a coating composition. Such compositions may aid to maintain contact between the compound of the invention or a composition containing thereof, and a weed.

In some embodiments, an adherent is selected from the group consisting of: alginate, a gum, a starch, a lecithin, formononetin, polyvinyl alcohol, alkali formononetinate, hesperetin, polyvinyl acetate, a cephalin, Gum Arabic, Xanthan Gum, Mineral Oil, Polyethylene Glycol (PEG), Polyvinyl pyrrolidone (PVP), Arabino-galactan, Methyl Cellulose, PEG 400, Chitosan, Polyacrylamide, Polyacrylate, Polyacrylonitrile, Glycerol, Triethylene glycol, Vinyl Acetate, Gellan Gum, Polystyrene, Polyvinyl, Carboxymethyl cellulose, Gum Ghatti, and a polyoxyethylene-polyoxybutylene block copolymer. Other examples of adherent compositions that can be used in the synthetic preparation include those described in EP 0818135, CA 1229497, WO 2013090628, EP 0192342, WO 2008103422 and CA 1041788.

In some embodiments, the plant nutrient is selected from, but is not limited to nitrogen based anions (such as an agriculturally acceptable nitrate or nitrite salt), phosphorus based anions (such as an agriculturally acceptable phosphate salt), an agriculturally acceptable potassium salt, a metal salt (such as an agriculturally acceptable Mg (II)-, Zn (II)-, and Mn (II) salt) or any combination thereof.

In some embodiments, the composition is characterized by a percolation distance within a growth medium (e.g. soil) in a range from 0 to 60 cm, from 0 to 5 cm, from 5 to 10 cm, from 10 to 60 cm, from 5 to 60 cm, from 5 to 40 cm, from 10 to 40 cm, from 10 to 30 cm, including any range therebetween.

In some preferred embodiments, the composition is characterized by a percolation distance within a growth medium (e.g. soil) in a range from 1 to 30 cm, from 1 to 5 cm, from 5 to 10 cm, from 10 to 30 cm, from 5 to 30 cm, from 10 to 20 cm, from 15 to 30 cm, from 10 to 30 cm, including any range therebetween.

In a preferred embodiment, the composition of the invention is characterized by a percolation distance within a growth medium (e.g. soil) in a range from 1 to 30 cm, from 1 to 5 cm, from 5 to 10 cm, from 10 to 30 cm, from 5 to 30 cm, from 10 to 20 cm, from 15 to 30 cm, from 10 to 30 cm, including any range therebetween.

In some preferred embodiments, the composition of the invention is characterized by a percolation distance within a growth medium (e.g. soil), wherein the percolation distance is sufficient for substantial reduction (e.g. at least 80%, at least 95%, at least 99% reduction including any range between) and/or eradication of soil-borne pathogens, when substantial is as described herein. One skilled in the art will appreciate, that the compositions disclosed herein, may be used in the reduction and/or eradication of soil-borne pathogens, which are typically located within the soil at a soil depth ranging from 1 to 30 cm. Various soil-borne pathogens are known in the art (such as Forl).

In some embodiments, the composition of the invention is for use in the reduction and/or eradication of pathogen load in the soil and/or area under cultivation. In some embodiments, the composition of the invention is for use in the reduction and/or eradication of pathogen load in the rhizosphere. In some embodiments, the composition of the invention is for use in the reduction and/or eradication of soil-borne pathogens. In some embodiments, the composition of the invention is for use in the reduction and/or eradication of soil-borne pathogens located at a soil depth ranging from 1 to 30 cm, wherein reduction and/or eradication is as described herein.

In some embodiments, the composition of the invention is for use in the reduction and/or eradication of soil-borne pathogens such as Pythium spp. (e.g., Pythium ultimum, Pythium aphanidermatum); Sclerotium spp. (e.g., Sclerotium rolfsii); Fusarium spp, particularly, Fusarium oxysporum f. sp. radicis-lycopersici (Forl), or any combination thereof.

In some embodiments, the composition of the invention improves the percolation distance of the pesticide within a growth medium (e.g. soil). In some embodiments, the percolation distance of the pesticide within a growth medium increases by at least 10%, at least 20%, at least 40%, at least 60%, at least 80%, at least 100%, at least 200%, at least 300%, at least 400%, at least 500%, at least 600%, at least 700%, at least 800%, at least 1000%, when applied to the growth medium as a part of the composition, compared to a pristine pesticide (e.g. the same composition being substantially devoid of the surfactant).

In some embodiments, the composition of the invention is characterized by substantially uniform distribution within a growth medium up to a distance (in a vertical dimension, in a horizontal dimension or both) ranging between 10 and 60 cm, between 1 and 30 cm between 1 and 10 cm, between 10 and 20 cm, between 10 and 30 cm, between 20 and 50 cm, including any range therebetween.

In some embodiments, the substantially uniform distribution comprises the effective concentration of the pesticide within a growth medium (e.g. soil) up to a depth between 10 and 60 cm. In some embodiments, the concentration of the pesticide within the growth medium or soil up to a depth between 10 and 60 cm is at least 30 ppm, at least 40 ppm, at least 60 ppm, at least 70 ppm, at least 80 ppm, at least 100 ppm, at least 150 ppm, at least 200 ppm including any range therebetween. In some embodiments, the concentration of the pesticide within the growth medium or soil up to a depth between 1 and 30 cm is sufficient to reduce or to control pest load within the growth medium or soil.

In some embodiments, the percolation distance of the pristine pesticide within a growth medium is up to 10 cm. In some embodiments, the pristine pesticide is devoid of a surfactant.

In some embodiments, the composition of the invention is substantially non-phytotoxic. In some embodiments, the composition of the invention is substantially non-phytotoxic when applied to the are under cultivation at a ratio of the pesticide to the soil of up to 600 l/hectare, up to 800 l/hectare, up to 1000 l/hectare including any range between.

In some embodiments, the composition of the invention is in a form of a kit. In some embodiments, the kit comprises the composition of the invention together with a packaging material (e.g. a storage container). In some embodiments, the kit of the invention comprises a pesticidal effective amount of the active ingredient (e.g. pesticide of the invention).

In some embodiments, the invention provides an article comprising any of the compositions of the invention. In some embodiments, the article is a packaged agricultural formulation.

In one embodiment, the present invention provides combined preparations. In one embodiment, “a combined preparation” defines especially a “kit” or a “kit of parts” in the sense that the combination partners as defined above can be dosed independently or by use of different fixed combinations with distinguished amounts of the combination partners i.e., simultaneously, concurrently, separately or sequentially. In some embodiments, the parts of the kit of parts can then, e.g., be applied (e.g. to the soil and/or area under cultivation) simultaneously or chronologically staggered, that is at different time points and with equal or different time intervals for any part of the kit of parts. The ratio of the total amounts of the combination partners, in some embodiments, can be administered in the combined preparation. In one embodiment, the combined preparation can be varied, e.g., in order to cope with the needs of a particular application or pest treatment, as can be readily made by a person skilled in the art.

In one embodiment, compositions of the present invention are presented in a pack or dispenser device, which contains, one or more unit dosages forms containing the active ingredient and optionally any one of a solvent, a surfactant and/or a stabilizer, as described herein.

In one embodiment, the pack or dispenser device is accompanied by instructions for application such as, dilution, dosing and/or preferred application method. In one embodiment, the pack or dispenser device is accompanied by instructions for dilution of the composition, so as to obtain a dosage containing an effective amount of the pesticide. In one embodiment, the pack or dispenser is accommodated by a notice associated with the container in a form prescribed by a governmental agency regulating the manufacture, use or sale of agrochemicals, which notice is reflective of approval by the agency of the form of the application of an agricultural composition.

### The Method

According to another aspect, there is provided a method for controlling a pest or reducing growth thereof, comprising providing the agricultural composition of the invention; and contacting a pesticidally effective amount of the agricultural composition with a locus (e.g. soil) infested with the pest. In some embodiments, the method is for controlling or reducing growth of the pest at a depth ranging from 0 to 60 cm within the locus.

The term “locus” as used herein, means a habitat, breeding ground, plant, seed, soil, material, or environment, in which a pest is growing, may grow, or may traverse. For example, a locus may be: where crops, trees, fruits, cereals, fodder species, vines, turf, and/or ornamental plants, are growing; where domesticated animals are residing; the interior or exterior surfaces of buildings (such as places where grains are stored); the materials of construction used in buildings (such as impregnated wood); and the soil around buildings. In some embodiments, the terms “locus” and “area under cultivation” are used herein interchangeably.

In some embodiments, the method induces an accumulation of a pesticide effective amount of the pesticide within the substrate. In some embodiments, the method induces an accumulation of a pesticide effective amount of the pesticide within the substrate at a depth ranging from 0 to 60 cm, from 0 to 5 cm, from 5 to 10 cm, from 10 to 60 cm, from 5 to 60 cm, from 5 to 40 cm, from 10 to 40 cm, from 10 to 30 cm, including any range therebetween.

In some embodiments, the method induces an accumulation of the pesticide at a w/w concentration between 1 and 1000 ppm, 10 and 1000 ppm, 1 and 10 ppm, between 10 and 100 ppm, between 30 and 100 ppm within the substrate at a depth ranging from 5 to 60 cm.

In some embodiments, contacting comprises exposing the pest or a pathogen to an effective concentration of the pesticide. In some embodiments, the terms “pest” and pathogen are used herein interchangeably.

In some embodiments, the method is for killing a soil pathogen or for reducing soil pathogen load. In some embodiments, the method is for reducing a soil pathogen growth. In some embodiments, the method is for reducing overall damage to a plant or plant part.

In some embodiments, the method is for killing a pathogen or reducing growth thereof by administering to a plant or soil, the composition described hereinabove.

In some embodiments, the pest is a pathogenic parasite. In some embodiments, the pest comprises at least one of nematodes, wireworms, insects, fungi, microorganisms and weed.

In some embodiments, the pathogen is a nematode selected from, but not limited to: parasitic nematodes such as root-knot, reniform, cyst, and lesion nematodes, including but not limited to Aphelenchoides spp., Belonolaimus spp., Bursaphalenchus spp., Criconema spp. Globodera spp., Meloidogyne spp., Tylenchorhynchus spp., Helicotylenchus spp., Heterodera spp., Hoplolaimus spp., Pratylenchus spp., Rotylenchulus spp., Trichodorus spp., and Xiphinema spp. In particular, the parasitic nematodes may include but are not limited to seed gall nematodes (Afrina wevelli), bentgrass nematodes (Anguina agrostis), shoot gall nematodes (Anguina spp.), seed gall nematodes (Anguina spp., A. amsinckiae, A. balsamophila; A. tritici), fescue leaf gall nematodes (A. graminis), ear-cockle (or wheat gall) nematodes (Anguina tritici), bud and leaf (or foliar) nematodes (Aphelenchoides spp., A. subtenuis), begonia leaf (or fern, or spring crimp, or strawberry foliar, or strawberry nematodes, or summer dwarf) nematodes (A. fragariae), fern nematodes (A. olesistus), rice nematodes (A. oryzae), currant nematodes (A. ribes), black currant (or chrysanthemum) nematodes (A. ritzemabosi), chrysanthemum foliar or leaf nematodes (A. ritzemabosi), rice white-tip (or spring dwarf, or strawberry bud) nematodes (A. besseyi), fungus-feeding (mushroom) nematodes (Aphelenchoides composticola), Atalodera spp. (Atalodera lonicerae, Atalodera ucri), spine nematodes (Bakernema variabile), sting nematodes (Belonolaimus spp., B. gracilis, B. longicaudatus), pine wood nematodes (Bursaphalenchus spp., B. xylophilus, B. mucronatus), sessile nematodes (Cacopaurus spp., C. epacris, C. pestis), amaranth cyst nematodes (Cactodera amaranthi), birch cyst nematodes (C. betulae), cactus cyst nematodes (C. cacti), estonian cyst nematodes (C. estonica), Thorne's cyst nematodes (C. thornei), knotweed cyst nematodes (C. weissi), ring nematodes (Criconema spp.), spine nematodes (Criconema spp., C. civellae, C. decalineatum, C. spinalineatum), ring nematodes (Criconemella axeste, C. curvata, C. macrodora, C. parva), ring nematodes (Criconemoides spp., C. citri, C. simile), spine nematodes (Crossonema fimbriatum), eucalypt cystoid nematodes (Cryphodera eucalypti), bud, stem and bulb nematodes (Ditylenchus spp., D. angustus, D. dipsaci, D. destructor, D. intermedius), Mushroom spawn nematodes (D. myceliophagus), awl nematodes (Dolichodorus spp., D. heterocephalus, D. heterocephalous), spear nematodes (Dorylaimus spp.), stunt nematodes (Geocenamus superbus), cyst nematodes (Globodera spp.), yarrow cyst nematodes (G. achilleae), milfoil cyst nematodes (G. millefolii), apple cyst nematodes (G. mali), white cyst potato nematodes (G. pallida), golden nematodes (G. rostochiensis), tobacco cyst nematodes (G. tabacum), Osborne's cyst nematodes (G. tabacum solanacearum), horsenettle cyst nematodes (G. tabacum virginiae), pin nematodes (Gracilacus spp., G. idalimus), spiral nematodes (Helicotylenchus spp., H. africanus, H. digonicus, H. dihystera, H. erythrinae, H. multicinctus, H. paragirus, H. pseudorobustus, H. solani, H. spicaudatus), sheathoid nematodes (Hemicriconemoides spp., H. biformis, H. californianus, H. chitwoodi, H. floridensis, H. wessoni), sheath nematodes (Hemicycliophora spp., H. arenaria, H. biosphaera, H. megalodiscus, H. parvana, H. poranga, H. sheri, H. similis, H. striatula), cyst nematodes (Heterodera spp.), almond cyst nematodes (H. amygdali), oat (or cereal) cyst nematodes (H. avenae), Cajanus (or pigeon pea) cyst nematodes (H. cajani), Bermuda grass (or heart-shaped, or Valentine) cyst nematodes (H. cardiolata), carrot cyst nematodes (H. carotae), cabbage cyst nematodes or brassica root eelworm (H. cruciferae), nutgrass (or sedge) cyst nematodes (H. cyperi), Japanese cyst nematodes (H. elachista), fig (or ficus, or rubber) cyst nematodes (H. fici), galeopsis cyst nematodes (H. galeopsidis), soybean cyst nematodes (H. glycines), alfalfa root (or pea cyst) nematodes (H. goettingiana), buckwheat cyst nematodes (H. graduni), barley cyst nematodes (H. hordecalis), hop cyst nematodes (H. humuli), Mediterranean cereal (or wheat) cyst nematodes (H. latipons), lespedeza cyst nematodes (H. lespedezae), Kansas cyst nematodes (H. longicolla), cereals root eelworm or oat cyst nematodes (H. major), grass cyst nematodes (H. mani), lucerne cyst nematodes (H. medicaginis), cyperus (or motha) cyst nematodes (Heterodera mothi), rice cyst nematodes (H. oryzae), Amu-Darya (or camel thorn cyst) nematodes (H. oxiana), dock cyst nematodes (H. rosii), rumex cyst nemtodes (H. rumicis), sugar beet cyst nematodes (H. schachtii), willow cyst nematodes (H. salixophila), knawel cyst nematodes (H. scleranthii), sowthistle cyst nematodes (H. sonchophila), tadzhik cyst nematodes (H. tadshikistanica), turkmen cyst nematodes (H. turcomanica), clover cyst nematodes (H. trifolii), nettle cyst nematodes (H. urticae), ustinov cyst nematodes (H. ustinovi), cowpea cyst nematodes (H. vigni), corn cyst nematodes (H. zeae), rice root nematodes (Hirschmanniella spp., H. belli, H. caudacrena, H. gracilis, H. oryzae), lance nematodes (Hoplolaimus spp.), Columbia nematodes (H. columbus), Cobb's lance nematodes (H. galeatus), crown-headed lance nematodes (H. tylenchiformis), pseudo root-knot nematodes (Hypsoperine graminis), needle nematodes (Longidorus spp., L. africanus, L. sylphus), ring nematodes (Macroposthonia (=Mesocriconema) xenoplax), cystoid nematodes (Meloidodera spp.), pine cystoid nematodes (M. floridensis), tadzhik cystoid nematodes (M. tadshikistanica), cystoid body nematodes (Meloidoderita spp.), stunt nematodes (Merlinius spp., M. brevidens, M. conicus, M. grandis, M. microdorus), root-knot nematodes (Meloidogyne spp., M. acronea, M. arenaria, M. artiellia, M. brevicauda, M. camelliae, M. carolinensis, M. chitwoodi, M. exigua, M. graminicola, M. hapla, M. hispanica, M. incognita, M. incognita acrita, M. indica, M. inornata, M. javanica, M. kikuyuensis, M. konaensis, M. mali, M. microtyla, M. naasi, M. ovalis, M. platani, M. querciana, M. sasseri, M. tadshikistanica, M. thamesi), knapweed nematodes (Mesoanguina picridis), Douglas fir nematodes (Nacobbodera chitwoodi), false root-knot nematodes (Nacobbus aberrans, N. batatiformis, N. dorsalis), sour paste nematodes (Panagrellus redivivus), beer nematodes (P. silusiae), needle nematodes (Paralongidorus microlaimus), spiral nematodes (Pararotylenchus spp.), stubby-root nematodes (Paratrichodorus allius, P. minor, P. porosus, P. renifer), pin nematodes (Paratylenchus spp., P. baldaccii, P. bukowinensis, P. curvitatus, P. dianthus, P. elachistus, P. hamatus, P. holdemani, P. italiensis, P. lepidus, P. nanus, P. neoamplycephalus, P. similis), lesion (or meadow) nematodes (Pratylenchus spp., P. alleni, P. brachyurus, P. coffeae, P. convallariae, P. crenatus, P. flakkensis, P. goodeyi, P. hexincisus, P. leiocephalus, P. minyus, P. musicola, P. neglectus, P. penetrans, P. pratensis, P. scribneri, P. thornei, P. vulnus, P. zeae), stem gall nematodes (Pterotylenchus cecidogenus), grass cyst nematodes (Punctodera punctate), stunt nematodes (Quinisulcius acutus, Q. capitatus), burrowing nematodes (Radopholus spp.), banana-root nematodes (R. similis), rice-root nematodes (R. oryzae), red ring (or coconut, or cocopalm) nematodes (Rhadinaphelenchus cocophilus), reniform nematodes (Rotylenchulus spp., R. reniformis, R. parvus), spiral nematodes (Rotylenchus spp., R. buxophilus, R. christiei, R. robustus), Thorne's lance nematodes (R. uniformis), Sarisodera hydrophylla, spiral nematodes (Scutellonema spp., S. blaberum, S. brachyurum, S. bradys, S. clathricaudatum, S. christiei, S. conicephalum), grass root-gall nematodes (Subanguina radicicola), round cystoid nematodes (Thecavermiculatus andinus), stubby-root nematodes (Trichodorus spp., T. christiei, T. kurumeensis, T. pachydermis, T. primitivus), vinegar eels (or nematodes) (Turbatrix aceti), stunt (or stylet) nematodes (Tylenchorhynchus spp., T. agri, T. annulatus, T. aspericutis, T. claytoni, T. ebriensis, T. elegans, T. golden, T. graciliformis, T. martini, T. mashhoodi, T. microconus, T. nudus, T. oleraceae, T. penniseti, T. punensis), citrus nematodes (Tylenchulus semipenetrans), dagger nematodes (Xiphinema spp., X. americanum, X. bakeri, X. brasiliense, X. brevicolle, X. chambersi, X. coxi, X. diversicaudatum X. index, X. insigne, X. nigeriense, X. radicicola, X. setariae, X. vulgarae, X. vuittenezi). In a preferred embodiment, a nematode controlled is a member of the Meloidogyne spp, particularly, M. javanica.

In some embodiments, the pathogen is a fungus selected from, but not limited to: mold, Alternaria spp. (e.g., Alternaria alternata, Alternaria solani); Aphanomyces spp. (e.g., Aphanomyces euteiches); Aspergillus spp. (e.g., Aspergillus niger, Aspergillus fumigatus); Athelia spp. (e.g., Athelia rolfsii); Aureobasidium spp. (e.g., Aureobasidium pullulans); Bipolaris spp. (e.g. Bipolaris zeicola, Bipolaris maydis); Botrytis spp. (e.g., Botrytis cinerea); Calonectria spp. (e.g., Calonectria kyotensis); Cephalosporium spp. (e.g., Cephalosporium maydis); Cercospora spp. (e.g., Cercospora medicaginis, Cercospora sojina, Colletotrichum coccodes, Colletotrichum fragariae, Colletotrichum graminicola); Coniella spp. (e.g., Coniella diplodiella); Colletotrichum spp.; Coprinopsis spp. (e.g., Coprinopsis psychromorbida); Corynespora spp. (e.g., Corynespora cassiicola; Curvularia spp. (e.g., Curvularia pallescens); Cylindrocladium spp. (e.g., Cylindrocladium crotalariae); Diplocarpon spp. (e.g., Diplocarpon earlianum); Diplodia spp. (e.g., Diplodia gossyina); Epicoccum spp. (e.g., Epicoccum nigrum); Erysiphe spp. (Erysiphe cichoracearum); Fusarium spp. (e.g., Fusarium graminearum, Fusarium oxysporum f. sp. fragariae, Fusarium oxysporum f. sp. tuberosi, Fusarium proliferatum var. proliferatum, Fusarium solani, Fusarium verticillioides, Fusarium clumorum, Fusarium oxysporum f. sp. radicis-lycopersici, Fusarium euwallaceae); Ganoderma spp. (e.g., Ganoderma boninense); Geotrichum spp. (e.g., Geotrichum candidum); Glomerella spp. (e.g., Glomerella tucumanensis); Guignardia spp. (e.g., Guignardia bidwellii); Kabatiella spp. (e.g., Kabatiella zeae); Leptosphaerulina spp. (e.g., Leptosphaerulina briosiana); Leptotrochila spp. (e.g., Leptotrochila medicaginis); Macrophomina spp. (e.g., Macrophomina phaseolina); Magnaporthe spp. (e.g., Magnaporthe grisea, Magnaporthe oryzae); Microsphaera spp. (e.g., Microsphaera manshurica); Monilinia spp. (e.g., Monilinia fructicola); Mucor spp.; Mycosphaerella spp. (e.g., Mycosphaerella juiensis, Mycosphaerella fragariae); Nigrospora spp. (e.g., Nigrospora oryzae); Ophiostoma spp. (e.g., Ophiostoma ulmi); Penicillium spp. (e.g., Penicillium digitatum); Peronospora spp. (e.g., Peronospora manshurica); Phakopsora (e.g., Phakopsora pachyrhizi); Phoma spp. (e.g., Phoma foveata, Phoma medicaginis, Phoma tracheiphila); Phomopsis spp (e.g. Phomopsis longicolla); Phytophthora spp. (e.g., Phytophthora cinnamomi, Phytophthora erythroseptica, Phytophthora fragariae, Phytophthora infestans, Phytophthora medicaginis, Phytophthora megasperma, Phytophthora palmivora); Podosphaera (e.g., Podosphaera leucotricha); Pseudopeziza spp. (e.g., Pseudopeziza medicaginis); Puccinia spp. (e.g., Puccinia graminis subsp. tritici (UG99), Puccinia striiformis, Puccinia recodita, Puccinia sorghi); Pyricularia spp. (Pyricularia grisea, Pyricularia oryzae); Pythium spp. (e.g., Pythium ultimum, Pythium aphanidermatum); Rhizoctonia spp. (e.g., Rhizoctonia solani, Rhizoctonia zeae); Rosellinia spp., Sclerotinia spp. (e.g., Sclerotinia minor; Sclerotinia sclerotiorum, Sclerotinina trifoliorum); Sclerotium spp. (e.g., Sclerotium rolfsii); Septoria spp. (e.g., Septoria glycines, Septoria lycoperski); Setomelanomma spp. (e.g., Setomelanomma turcica); Sphaerotheca spp. (e.g., Sphaerotheca macularis); Spongospora spp. (e.g., Spongospora subterranean); Stemphylium spp., Synchytrium spp. (e.g., Synchytrium endobioticum), Verticillium spp. (e.g., Verticillium albo-atrum, Verticillium dahliae). In a particular embodiment, the fungus is a member of the Botrytis spp. (e.g., Botrytis cinerea), Sclerotinia spp. (Sclerotinia minor), Sclerotium spp. (e.g., Sclerotium rolfsii), Macrophomina spp. (e.g., Macrophomina phaseolina), Verticillium spp. (e.g., Verticillium dahliae), Fusarium spp. (e.g., Fusarium oxysporum f. sp. Fragariae, Fusarium oxysporum f. sp. Radicis-cucumerinum, Rhizoctonia spp. (e.g., Rhizoctonia solani), Pythium spp. (e.g., Pythium ultimum).

In a preferred embodiment, a fungus controlled is a member of the Sclerotium spp, particularly, Sclerotium rolfsii, or a member of the Fusarium spp, particularly, Fusarium oxysporum f. sp. radicis-lycopersici (Forl) and/or a member of Pythium spp. (e.g., Pythium ultimum, Pythium aphanidermatum), or any combination thereof.

In some embodiments, the pathogen is an insect. In some embodiments, the pathogen is a wireworm. In some embodiments, the pathogen is a weed.

In some embodiments, the pathogen is an aphid selected from, but is not limited to: Myzus persicae, Aphis gossypii, Brevicoryne brassicae, Aphis nerii, Bemisia tabaci and Rhopalosiphum maidis.

According to some embodiments of the present invention, the disclosed compositions are for use for reducing growth of a pathogen.

In some preferred embodiments, the method of the invention is for inducing a substantial reduction (e.g. at least 80%, at least 95%, at least 99% reduction including any range between) and/or eradication of soil-borne pathogens, when substantial is as described herein. One skilled in the art will appreciate, that the methods of applying the composition(s) disclosed herein, may be for the reduction and/or eradication of soil-borne pathogens, which are typically located within the soil at a soil depth ranging from 1 to 30 cm. Various soil-borne pathogens are known in the art (such as Forl).

In some embodiments, the method of the invention is for use in the reduction and/or eradication of pathogen load in the soil and/or area under cultivation. In some embodiments, the method of the invention is for use in the reduction and/or eradication of pathogen load in the rhizosphere. In some embodiments, the method of the invention is for use in the reduction and/or eradication of soil-borne pathogens. In some embodiments, the method of the invention is for use in the reduction and/or eradication of soil-borne pathogens located at a soil depth ranging from 1 to 30 cm, wherein reduction and/or eradication is as described herein.

In some embodiments, the method of the invention is for use in the reduction and/or eradication of soil-borne pathogens such as Pythium spp. (e.g., Pythium ultimum, Pythium aphanidermatum); Sclerotium spp. (e.g., Sclerotium rolfsii); Fusarium spp, particularly, Fusarium oxysporum f. sp. radicis-lycopersici (Forl), or any combination thereof.

In some embodiments, the term “reducing”, or any grammatical derivative thereof, indicates that at least 20%, 30%, 40%, 50%, 60%, 70%, 80%, 90%, or more, reduction of growth or even complete growth inhibition in a given time as compared to the growth in that given time of the pathogen not being exposed to the treatment as described herein. In some embodiments, the term “reducing”, or any grammatical derivative thereof, refers to reduction of pest load at a soil depth ranging from 1 to 5 cm, from 5 to 10 cm, from 10 to 60 cm, from 5 to 60 cm, from 5 to 40 cm, from 1 to 30 cm, from 10 to 20 cm, from 10 to 25 cm, from 10 to 40 cm, from 10 to 30 cm, including any range therebetween.

In some embodiments, the term “completely inhibited”, or any grammatical derivative thereof, refers to 100% arrest of growth in a given time as compared to the growth in that given time of the fungi not being exposed to the treatment as described herein. In some embodiments, the terms “completely inhibited” and “eradicated” including nay grammatical form thereof, are used herein interchangeably. In some embodiments, the term “eradication”, or any grammatical derivative thereof, refers to eradication of pest load at a soil depth ranging from 1 to 5 cm, from 5 to 10 cm, from 10 to 60 cm, from 5 to 60 cm, from 5 to 40 cm, from 1 to 30 cm, from 10 to 20 cm, from 10 to 25 cm, from 10 to 40 cm, from 10 to 30 cm, including any range therebetween.

In some embodiments, the method is directed to storing a plant or plant part, comprising exposing a post-harvest plant or plant part to an effective amount of the composition.

In some embodiments, the plant or plant part is pre-harvested.

In some embodiments, the substrate is selected from the group consisting of: a plant, parts of the plant, area under cultivation and growth medium (such as soil) or any combination thereof.

As used herein, the terms “contacting” or “exposing” comprise: immersion, coating, irrigating, dipping, spraying, fogging, scattering, painting, injecting, or any combination thereof.

In some embodiments, the composition is applied to the soil using methods known in the art. These include but are not limited to: (a) drip irrigation or chemigation; (b) soil incorporation; (c) seed treatment.

In some embodiments, the composition is applied to plants. In some embodiments, the composition is applied to plant parts. In some embodiments, the plant or plant part may be pre-harvest (rooted in the soil or hydroponics, open field, greenhouse etc.) or post-harvest. In some embodiments, the composition is applied to desired and undesired wild plants or crop plants (including naturally occurring crop plants). In some embodiments, the composition is applied to one or more plant parts selected from, but not limited to: shoot, leaf, flower, root, leaves, needles, stalks, stems, flowers, fruit bodies, seeds, roots, harvested material, vegetative and generative propagation material tubers, cuttings, offshoots, rhizomes and all parts and organs of plants above and below the ground.

In some embodiments, the composition is exposed to the pathogen, soil, plant or part thereof. By “exposing” it is meant to refer to contacting directly or, in some embodiments, allowing the composition to act on their surroundings, habitat or storage space by, for example, irrigation, immersion, coating, dipping, spraying, evaporation, fogging, scattering, painting on, or by injecting.

As used herein, the term “growth medium” is related to any growth substrate including soil.

In some embodiments, the agricultural composition of the invention is applied to the soil or area under cultivation wherein application is selected from pre-planting, post-planting, pre-seeding, post-seeding, pre-harvesting, and post-harvesting or any combination thereof. The intended use of the agricultural composition disclosed herein, is for soil applications either by irrigation, immersion, coating, dipping, spraying or incorporating into the soil.

In some embodiments, agricultural composition of the invention is applied to the rhizosphere. In some embodiments, agricultural composition of the invention is mixed with other dry fertilizer ingredients prior to application or used alone.

In some embodiments, the composition is exposed to the growth medium at a dosage ranging from 0.3 to 30 g/m², from 0.3 to 1 g/m², from 1 to 5 g/m², from 2 to 5 g/m², from 1 to 10 g/m², from 5 to 10 g/m², from 10 to 30 g/m², from 10 to 20 g/m², from 20 to 30 g/m² including any range or value therebetween, wherein the dose refers to a weight ratio of the pesticide to a surface area.

In some embodiments, the composition is exposed to the growth medium at a dosage ranging from Ho 120 g/m³, from 1 to 10 g/m³, from 10 to 20 g/m³, from 20 to 30 g/m³, from 30 to 40 g/m³, from 40 to 50 g/m³, from 50 to 60 g/m³, from 60 to 70 g/m³, from 70 to 80 g/m³, from 80 to 100 g/m³, from 100 to 120 g/m³, including any range or value therebetween, wherein the dose refers to a weight ratio of the pesticide to a volume of the growth medium up to a depth of 30 cm.

In some embodiments, the agricultural composition of the invention is contacted with the soil or area under cultivation at an effective amount of between 5 and 50,000 l/hectare, between 10 and 100 l/hectare, between 100 and 200 l/hectare, between 100 and 200 l/hectare, between 200 and 300 l/hectare, between 300 and 400 l/hectare, between 400 and 500 l/hectare, between 500 and 1000 l/hectare, between 1000 and 5000 l/hectare, between 5000 and 10,000 l/hectare, between 10,000 and 50,000 l/hectare, including any range between. In some embodiments, the effective amount described herein, refers to the amount of the pesticide (e.g. trans-2-octenal) relative to the soil area. In some embodiments, the agricultural composition of the invention is contacted with the soil or area under cultivation at a fungicidally effective amount of between 200 and 1000 l/hectare, between 200 and 400 l/hectare, between 300 and 600 l/hectare, including any range between.

In some embodiments, the method is for reducing and/or eradicating a pest (e.g. a nematode) within the soil, the method comprises contacting the agricultural composition of the invention with the soil or area under cultivation at a nematocidally effective amount of between 100 and 200 l/hectare, between 200 and 300 l/hectare, between 300 and 400 l/hectare, between 400 and 500 l/hectare, including any range between.

In some embodiments, the method is for reducing and/or eradicating a pest (e.g. a fungi) within the soil, the method comprises contacting the agricultural composition of the invention with the soil or area under cultivation at a fungicidally effective amount of between 100 and 200 l/hectare, between 200 and 300 l/hectare, between 300 and 400 l/hectare, between 400 and 500 l/hectare, including any range between.

In some embodiments, the effective amount of the pesticide of the invention sufficient for pest (e.g. a fungi) eradication is at least 300 l/hectare, at least 310 l/hectare, at least 320 l/hectare, at least 330 l/hectare, at least 350 l/hectare, at least 370 l/hectare, at least 380 l/hectare, at least 390 l/hectare, at least 400 l/hectare, including any range between.

In some embodiments, the disclosed composition may be used as pesticides and in particular, may be used as e.g., nematocides, fungicides, insecticides, herbicides, or bactericides, alone or in combination with one or more pesticidal substances set forth above or known in the art.

In some embodiments, the disclosed composition may be applied to soil, plants or plant parts. In some embodiments, applying to the soil comprises application on or above the surface of the soil (such as by irrigation).

In some embodiments, the pesticide effective amount (in parts per million; ppm) (e.g., for inhibiting or killing a pathogen) is in the range of 0.1-50, 0.1-200, 0.1-300, 0.1-400, 0.1-500, 0.1-600, 0.1-700, 0.1-800, 0.1-1000, 0.1-1500, 0.1-2000, 0.1-2500, 0.1-3000, 0.1-5000, 0.2-50, 0.2-200, 0.2-300, 0.2-400, 0.2-500, 0.2-600, 0.2-700, 0.2-800, 0.2-1000, 0.2-1500, 0.2-2000, 0.2-2500, 0.2-3000, 0.2-5000, 0.5-50, 0.5-200, 0.5-300, 0.5-400, 0.5-500, 0.5-600, 0.5-700, 0.5-800, 0.5-1000, 0.5-1500, 0.5-2000, 0.5-2500, 0.5-3000, 0.5-5000, 1-50, 1-200, 1-300, 1-400, 1-500, 1-600, 1-700, 1-800, 1-1000, 1-1500, 1-2000, 1-2500, 1-3000, 1-5000, 2-50, 2-200, 2-300, 2-400, 2-500, 2-600, 2-700, 2-800, 2-1000, 2-1500, 2-2000, 2-2500, 2-3000, 2-5000, 5-50, 5-200, 5-300, 5-400, 5-500, 5-600, 5-700, 5-800, 5-1000, 5-1500, 5-2000, 5-2500, 5-3000, 5-5000, 25-50, 25-200, 25-300, 25-400, 25-500, 25-600, 25-700, 25-800, 25-1000, 25-1500, 25-2000, 25-2500, 25-3000, 25-5000, 50-200, 50-300, 50-400, 50-500, 50-600, 50-700, 50-800, 50-1000, 50-1500, 50-2000, 50-2500, 50-3000, or 50-5000 ppm. Each possibility represents a separate embodiment of the invention. In some embodiments, the effective concentration for inhibiting or killing a pathogen is 50-100 ppm. In some embodiments, the effective concentration for inhibiting or killing a pathogen is 500-1000 ppm.

In some embodiments, the effective concentration (in ppm) for inhibiting, or for killing a fungus is e.g., in the range of 0.1-50, 0.1-200, 0.1-300, 0.1-400, 0.1-500, 0.1-600, 0.1-700, 0.1-800, 0.1-1000, 0.2-50, 0.2-200, 0.2-300, 0.2-400, 0.2-500, 0.2-600, 0.2-700, 0.2-800, 0.2-1000, 0.5-50, 0.5-200, 0.5-300, 0.5-400, 0.5-500, 0.5-600, 0.5-700, 0.5-800, 0.5-1000, 1-50, 1-200, 1-300, 1-400, 1-500, 1-600, 1-700, 1-800, 1-1000, 2-50, 2-200, 2-300, 2-400, 2-500, 2-600, 2-700, 2-800, 2-1000, 5-50, 10-100, 30-100, 30-50, 40-100, 50-100, 50-80, 60-80, 5-200, 5-300, 5-400, 5-500, 5-600, 5-700, 5-800, 5-1000, 25-50, 25-200, 25-300, 25-400, 25-500, 25-600, 25-700, 25-800, 25-1000, 50-200, 50-300, 50-400, 50-500, 50-600, 50-700, 50-800, or 50-1000 ppm. Each possibility represents a separate embodiment of the invention. In some embodiments, the effective concentration for inhibiting or killing a fungus is 50-100 ppm. In some embodiments, the effective concentration for inhibiting or killing a fungus is 500-1000 ppm.

In some embodiments, the term “inhibiting”, or any grammatical derivative thereof, in the context of fungus refers to the inhibition of fungal development or fungal load.

In some embodiments, the effective concentration (in ppm) for inhibiting, or for killing a weed is e.g., in the range of 0.1-50, 0.1-200, 0.1-300, 0.1-400, 0.1-500, 0.1-600, 0.1-700, 0.1-800, 0.1-1000, 0.2-50, 0.2-200, 0.2-300, 0.2-400, 0.2-500, 0.2-600, 0.2-700, 0.2-800, 0.2-1000, 0.5-50, 0.5-200, 0.5-300, 0.5-400, 0.5-500, 0.5-600, 0.5-700, 0.5-800, 0.5-1000, 1-50, 1-200, 1-300, 1-400, 1-500, 1-600, 1-700, 1-800, 1-1000, 2-50, 2-200, 2-300, 2-400, 2-500, 2-600, 2-700, 2-800, 2-1000, 5-50, 10-100, 30-100, 30-50, 40-100, 50-100, 50-80, 60-80, 5-200, 5-300, 5-400, 5-500, 5-600, 5-700, 5-800, 5-1000, 25-50, 25-200, 25-300, 25-400, 25-500, 25-600, 25-700, 25-800, 25-1000, 50-200, 50-300, 50-400, 50-500, 50-600, 50-700, 50-800, or 50-1000 ppm. Each possibility represents a separate embodiment of the invention. In some embodiments, the effective concentration for inhibiting or killing a fungus is 50-100 ppm. In some embodiments, the effective concentration for inhibiting or killing a fungus is 500-1000 ppm.

In some embodiments, the term “effective concentration” as used herein, relates to a w/w concentration of the pesticide within the composition, as described hereinabove. In some embodiments, the term “effective concentration” as used herein, relates to a w/w concentration of the pesticide within the substrate (such as the growth medium or the edible matter).

In some embodiments, the term “effective concentration” as used herein, relates to a concentration of the pesticide at a depth ranging from 5 to 60 cm within the substrate.

In some embodiments, the method induces an accumulation of a pesticide effective amount of the pesticide within the substrate (such as at a depth ranging from 5 to 60 cm).

In some embodiments, the method induces accumulation of a pesticide effective amount of the pesticide within a growth medium at a depth ranging from 0 to 60 cm, from 0 to 10 cm, from 0 to 5 cm, from 5 to 10, from 5 to 40 cm, from 5 to 30 cm from 10 to 60 cm, from 10 to 50 cm, from 10 to 40 cm, from 10 to 30 cm, including any range or value therebetween.

In some embodiments, the method induces accumulation of the pesticide within a growth medium at a depth of at least 20, 22, 25, 30 cm, wherein a w/w ratio of the pesticide to the growth medium is between 10 and 1000 ppm, between 10 and 100 ppm, between 20 and 100 ppm, between 20 and 80 ppm, between 30 and 80 ppm, between 100 and 200 ppm, between 200 and 300 ppm, between 300 and 500 ppm, between 500 and 1000 ppm, including any range or value therebetween.

In some embodiments, the method induces accumulation of at least 10 ppm (w/w), at least 30 ppm (w/w), at least 40 ppm (w/w), at least 50 ppm (w/w), at least 60 ppm (w/w), at least 70 ppm (w/w), at least 80 ppm (w/w), at least 100 ppm (w/w), within a growth medium at a depth between 20 and 30 cm.

### General

As used herein the term “about” refers to ±10%.

The terms “comprises”, “comprising”, “includes”, “including”, “having” and their conjugates mean “including but not limited to”. The term “consisting of” means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

As used herein, the term “substantially” refers to at least 80%, at least 85%, at least 90%, at least 92%, at least 95%, at least 96%, at least 97%, at least 98%, at least 99%, including any range or value therebetween.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein, the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

### Example 1

### The Effect of SDS on the Percolation Depth

The effect of the surfactant (SDS) concentration on the soil percolation depth of trans-2-octenal was examined in field experiments. The experiments were performed in loam soil. Each repetition (triplicates per experiment) was defined by an irrigation square, which contained 7 droppers: six in the perimeter and one in the middle. The irrigation area was 0.56 m². For better percolation of trans-2-octenal, the soil was aerated before the experiment.

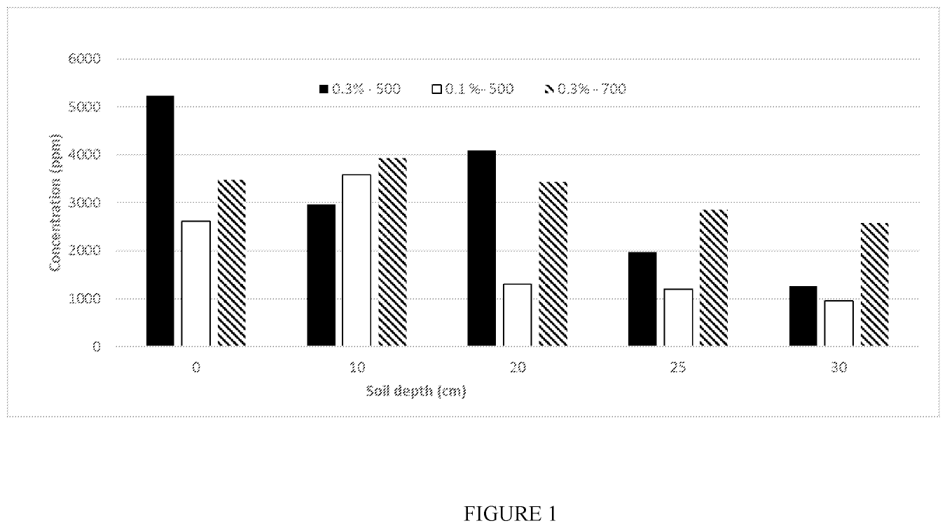

The soil was irrigated with an aqueous composition containing 700 ppm (w/w) of trans-2-octenal, 0.3% w/w of the antioxidant (ascorbic acid), and 0.3 or 0.1% w/w of SDS. The concentration of trans-2-octenal was then measured in the soil at depths of 0, 10, 20, 25, and 30 cm. The results of this experiment are summarized in FIG. 1.

Based on various field experiments, it was found that a composition comprising 0.3 or 0.1% w/w of the surfactant enabled accumulation of an effective concentration of trans-2-octenal up to a depth of at least 30 cm, as shown by FIG. 1.

### Example 2

### The Effect of Surfactants on the Percolation Depth

In order to estimate the effect of a particular surfactant on the soil percolation depth of trans-2-octenal, various field experiments were performed as described hereinabove (Example 1), however the concentrations of the surfactant and of the antioxidant (ascorbic acid) within the aqueous solution were lowered to about 400 ppm. For this comparative experiment, an anionic surfactant (SDS), a cationic surfactant (CTAC) and a non-ionic surfactant (polysorbate 20 or Tween 20) were used. The compositions comprising the non-ionic Tween 20 surfactant or the anionic SDS surfactant exhibited improved percolation depth of trans-2-octenal compared to the cationic CTAC-based composition.

### Example 3

### Anti Phytopathogenic Activity of Trans-2-Octenal with Various Surfactants

The effect of different surfactants on the antifungal activity of trans-2-octenal was examined using a similar aqueous composition as described in Example 2, however the ascorbic acid was replaced with sodium bisulfite. After organization of the irrigation squares, the pathogens (Fusarium oxysporum f. sp. radicis-lycopersici) were buried at depths of 10, 17, and 25 cm. Then, the composition was drip irrigated in 300-700 cub of water per hectare.

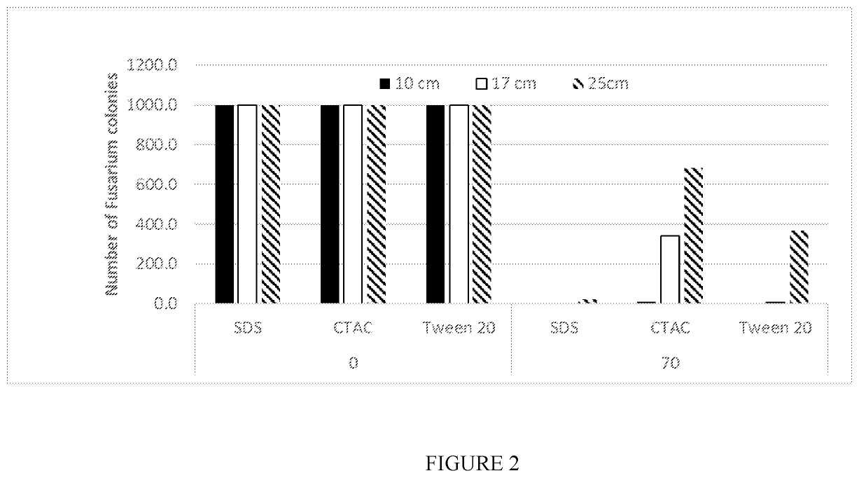

The viability of the fungus was determined by isolation of the fungus from three different depths of the soil (10, 17, and 25 cm) on PDA plates. The results of these experiments are represented by FIG. 2, pointing out that CTAC was significantly less effective than SDS and Tween 20.

### Example 4

### Anti Phytopathogenic Activity of Trans-2-Octenal with SDS

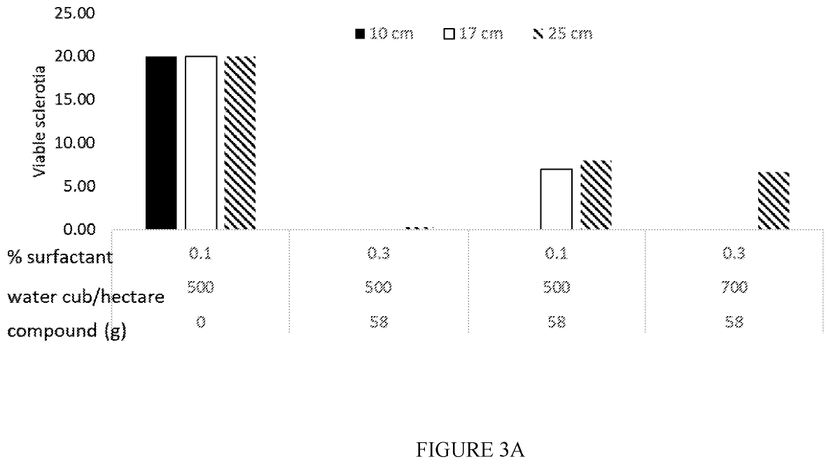

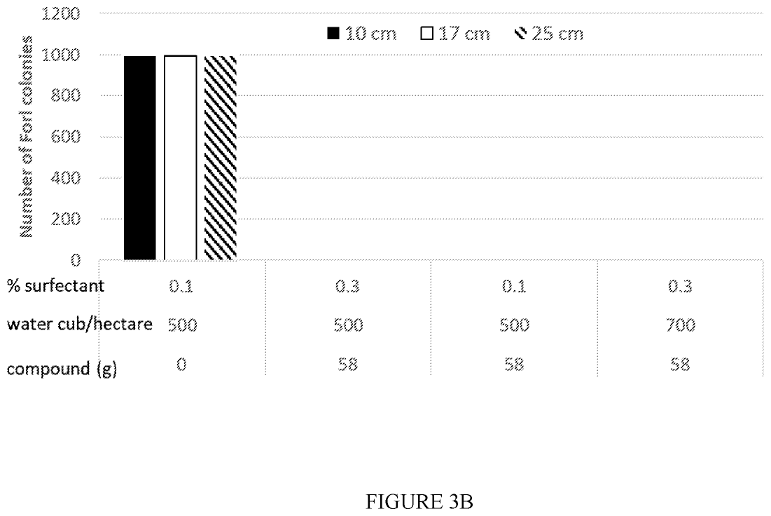

The effect of different concentrations of SDS (0.1 vs 0.3% w/w) on the antifungal activity of trans-2-octenal was examined using the same aqueous composition as described in Example 1. In this experiment, the antifungal activity of trans-2-octenal on Fusarium oxysporum f. sp. radicis-lycopersici and Sclerotinia rolfsii was evaluated. The results of these experiments are represented by FIGS. 3A and 3B.

### Example 5

### Effect of the Stabilizer on the Fungicidal Activity of Trans-2-Octenal

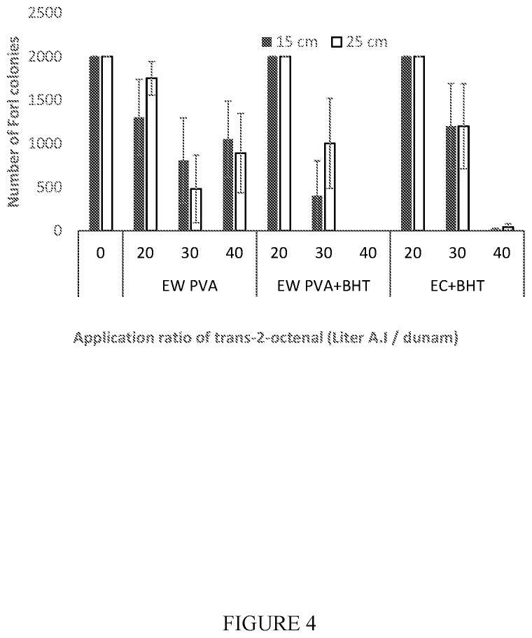

For this experiment, different formulations (1. EW formulation; 2. EX formulation; and 3. EW formulation without BHT as a negative control) containing trans-2-octenal have been tested. EW formulation and EC formulation are as described hereinbelow (Table 1 and 2). The results of this experiment are represented by FIG. 4.

TABLE 1
chemical composition of an exemplary EW formulation of
the invention

| Material | CAS | Description | Content (wt.%) |
|---|---|---|---|
| Trans-2-octenal | 2548-87-0 | Pesticide | 15-30% |
| Butylated | 128-37-0 | Stabilizer | 0.1-0.5% |
| hydroxytoluene (BHT) | | | |
| Proxel GXL | 2634-33-5 | Biocide | 0.10% |
| Propylene glycol | 57-55-6 | Co-solvent | 5-20.00% |
| Agnique CSO 40 (EL) | 61791-12-6 | Nonionic | 0.1-1% |
| | | surfactant | |
| Synperonic PE/L64 | 9003-11-6 | Nonionic | 0.1-1% |
| | | surfactant | |
| Xiameter AFE 1520 | | Antifoaming | 0.60% |
| | | emulsion | |
| Poval 6-88 (PVA) | 9002-89-5 | Surfactant | 5-15% |
| Water | | Solvent | 20-70% |

TABLE 2
chemical composition of an exemplary EC formulation of the invention

| Material | Description | Content (wt.%) |
|---|---|---|
| Trans-2-octenal | Pesticide | 50-70% |
| Dipropylene glycol | Co-solvent | 10-20% |
| Rhodacal BE/60 | Anionic surfactant anionic | 1-10% |
| | (HLB 8.3) | |
| Agnique CSO-35 | Nonionic surfactant | 1-10% |
| | (HLB 12.5) | |
| Butylated hydroxytoluene | Stabilizer | 0.5-1% |
| (BHT) | | |

The ability of the 2-octenal based formulations (the formulations are as described hereinabove) to eliminate the viability of the pathogen Forl (Fusarium oxysporum f. sp. radicis-lycopersici) in soil was examined.

To this end, small plastic bags containing 4 g of Forl pre-inoculated soil (4.3*10\hat{ }6 spores/g soil) were prepared. Each plastic bag was tied to a plastic string. There were two Forl containing plastic bags in each string. One end of the string was designated as point 0, which means that this point was set at the soil surface level. Then, one Forl containing plastic bag was tied to the string at 15 cm from point 0 and another plastic bag was tied at 25 cm from point 0. Thus, each string contained two Forl containing plastic bags tied at points corresponding to depths 15 and 25 cm in the soil. Each treatment was examined in a 6 square meter plot.

One day before application, the soil was irrigated using 20 m³/dunam. On the day of the application, the soil was aerated to the depth of 30 cm using an agricultural clod crusher. Then, each trans-2-octenal formulation was applied by infusion it to the soil surface. The application ratio was 1 liter of formulation per 1 square meter of soil.

Thus, per each 6 square meters of plot, the appropriate amount of formulation was diluted in water to a total volume of 6 L. Each formulation was examined in three concentrations: 20, 30, and 40 L (liter) of active ingredient (A.I) per dunam. A.I. refers to trans-2-octenal.

As a control, a 6 square meter plot was applicated with tap water. In the end of the trans-2-octenal applications, the soil was aerated again to the depth of 25 cm using an agricultural clod crusher. Then, the Forl containing strings were buried in the soil in the middle of each plot. There were 5 strings for each treatment. Last, the soil was irrigated again using 30 m³/dunam of water.

Four days after application, the viability of the Forl was examined as follows: the strings were pulled out of the soil. Each Forl containing plastic bag was open and a sample of 1 g was weighted. Then, each 1 g sample was transferred to a 15 mL falcon tube containing 9 mL of double distilled sterile H₂O. Next, each tube was mixed 3 times vigorously using vortex, and then a sample of 100 microliter was plated on a potato dextrose agar (PDA) plate supplemented with 12 microgram/mL tetracycline. The number of Forl colonies emerged after two days incubation at 25° C. was counted.

As shown in FIG. 4, the formulations containing BHT as a stabilizer exhibited a significant fungicidal activity upon application of 30 liter A.I per 0.1 ha soil. As shown in FIG. 4, application of 30 liter A.I per 0.1 ha soil by implementing EW formulation as described herein, resulted in about 50% and about 80% reduction of Forl colonies at a soil depth of 25 cm and 15 cm, respectively.

As shown in FIG. 4, application of 30 liter A.I per 0.1 ha soil by implementing EC formulation as described herein, resulted in about 40% reduction of Forl colonies at a soil depth of 15 cm and 25 cm.

Both EW and EC formulations almost completely eradicated Forl upon application of 40 liter A.I per 0.1 ha soil. According to additional experimental data (not shown), any of the EC and EW formulations exhibited a significant fungicidal activity (between 20 and 50% reduction of Forl colonies at a soil depth of between 10 and 30 cm) upon application of 20 liter A.I per 0.1 ha soil.

Accordingly, an antioxidant at a w/w concentration of between 0.1 and 1% within the composition of the invention resulted in a complete elimination of the pathogen Forl. In contrast, EW formulation which was not supplemented with BHT, did not eliminate completely pathogen's loading even in the highest concentration of 40 Liter A.I/dunam, resulting in only 50% reduction of Forl colonies at a soil depth of both 25 and 15 cm.

During the field studies with the formulations described herein, no phytotoxicity was observed up to an application ratio of 80 liter of trans-2-octenal per 0.1 hectare soil.

### Example 6

### Nematocidal Activity of an Exemplary Trans-2-Octenal Formulation

For this experiment, an exemplary EW formulation containing trans-2-octenal (see Table 1 above) has been utilized.

The nematicidal activity of the EW formulation in soil was examined. To this end, a nematode inoculated net house was prepared as follows: suspension of M. javanica infected roots was poured on the ground and then sensitive lettuce seedlings were planted. After approximately a month, the infected lettuce was chopped and mixed into the ground and then sensitive tomato seedlings were planted. Approximately one month before the beginning of the experiment, the foliage was eliminated, and the infected roots were mixed into the ground.

One day before application, the soil was irrigated with 20 m3/dunam soil. On the day of the application, the soil was aerated to the depth of 30 cm using an agricultural clod crusher. Trans-2-octenal (in a form of the EW formulation) was applied to the inoculated soil in three different ratios: 20, 30 and 40 liter trans-2-octenal per dunam soil. The EW formulation of trans-2-octenal was diluted in 6 litter of water, and the diluted formulation was applied by pouring to the soil using 9 tubes. Each concentration was examined in one plot of 6 square meters.

As a control, a 6 square meter plot was applicated with tap water. In the end of the trans-2-octenal applications, the soil was aerated again to the depth of 25 cm using an agricultural clod crusher. Last, the soil was irrigated again using 30 m3/dunam. Six days after application, 15 tomato seedlings (Maggie 1201, Shorashim) were planted in each treatment. Eleven weeks post application, 5 tomato plants from each treatment, along with their root system, were harvested from the soil. For evaluating nematode reproduction on root system, M. javanica eggs were extracted from each root, as follows: soil debris was carefully removed from washed root systems, and roots were weighed. Then, each root was cut to pieces (˜5 cm). Next, the root was immersed in 1% sodium hypochlorite (NaOCl) solution and chopped 3 times using a blender for 20 seconds. The chopped root was then transferred to successive sieving through filters of 400, 125, 63, and 25 micrometer mesh size. The eggs were collected from the bottom (25 micrometer mesh size). Then, the eggs were pelleted and suspended in 5 mL tap water. The number of eggs was counted using a bright line hemicytometer, and the number of eggs per gram of root was calculated for each repetition. The data was analyzed with the IMP 15 software package. Mean numbers of the number of eggs per gram root were subjected to one way analysis of variance (ANOVA), followed by Tukey-Kramer multiple comparison test, with significance set as P<0.05.

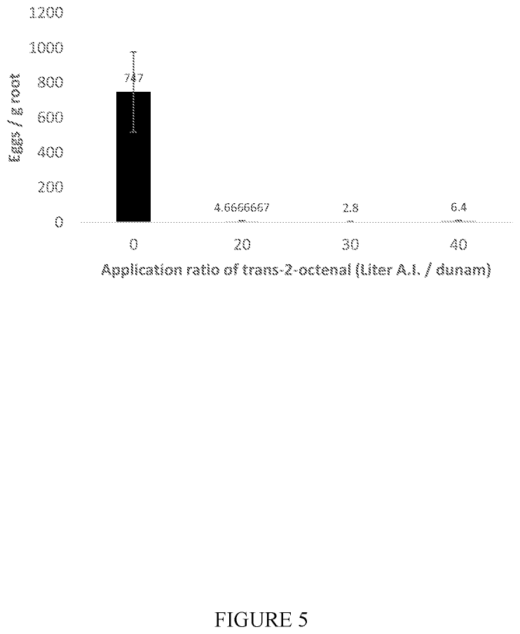

As shown in FIG. 5, EW trans-2-octenal formulation significantly reduced the number of M. javanica eggs per gram root even at concentration of 20 liter A.I. per dunam. This result suggests that the minimum effective amount of trans-2-octenal, sufficient for nematode eradication is between 10 and 20, wherein trans-2-octenal is implemented in a from of a composition of the invention (e.g. liquid formulation).

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. An agricultural composition comprising an agriculturally effective amount of a pesticide, a stabilizer and a surfactant; wherein:
(i) a weight ratio between said pesticide and said surfactant is between 10:1 and 1:1;
(ii) a weight ratio between said pesticide and said stabilizer is between 200:1 and 10:1
(iii) said surfactant comprises a non-ionic surfactant, an anionic surfactant or both; and
(iv) said pesticide comprises a (C5-C10) α,β unsaturated aldehyde.

2. The agricultural composition of claim 1, wherein a w/w concentration of said surfactant within the composition is between 1 and 30%.

3. The agricultural composition of claim 1, wherein said (C5-C10) α,β unsaturated aldehyde is selected from the group consisting of trans-2-octenal, trans-2-pentenal, trans-2-hexen-1-al, trans-2-nonenal, and trans-2-heptenal or any combination thereof.

4. The agricultural composition of claim 1, wherein said non-ionic surfactant is selected from the group consisting of alkoxylated fatty acid, glucosyl dialkyl ether, polysorbate, span, tween, a polyether, a polyol, a polysaccharide, a polypeptide, a polyester, polyvinyl acetate, polyacrylamide, and polyacrylate, including any mixture or a copolymer thereof.

5. The agricultural composition of claim 4, wherein said alkoxylated fatty acid comprises ethoxylated castor oil.

6. The agricultural composition of claim 1, wherein said anionic surfactant is selected from the group consisting of alkyl benzene sulfonate, alcohol ether sulfate, secondary alkane sulfonates and alkyl sulfates including any combination thereof.

7. The agricultural composition of claim 1, wherein said stabilizer is selected from the group consisting of phenol, alkyl phenol, hindered amine light stabilizer (HALS), an alkyl silane, amylene, ascorbic acid, a bisulfite salt, a metabisulfite salt, a sulfite salt, a thiol, SO₂, a hydroxide salt, a triethanolamine and dimethyl ethanolamine or any combination or a derivative thereof.

8. The agricultural composition of claim 7, wherein said alkyl phenol is selected from the group consisting of 2,6-di-tert-butylphenol, butylated hydroxytoluene (BHT), a cresol or any combination or a derivative thereof.

9. The agricultural composition of claim 1, wherein a w/w concentration of said stabilizer within said agricultural composition is between 0.1 and 5%, and wherein said stabilizer is BHT.

10. The agricultural composition of any claim 1, wherein said surfactant comprises polyvinyl alcohol (PVA), and wherein a w/w ratio between said pesticide and said surfactant is between 5:1 and 2:1.

11. The agricultural composition of claim 1, wherein said surfactant comprises ethoxylated castor oil and alkyl benzene sulfonate, and wherein a w/w ratio between said pesticide and said surfactant is between 8:1 and 2:1.

12. The agricultural of claim 1, further comprising an additive selected from the group consisting of a solvent, an anti-foaming agent, a preservative, a coloring agent, an odorizing agent or any combination thereof.

13. The agricultural composition of claim 12, wherein said solvent comprises an aqueous solvent, a water miscible solvent or both.

14. (canceled)

15. The composition of claim 13, wherein a weight per weight (w/w) concentration of said solvent within said composition is at least 10%.

16. The composition of claim 1, wherein said agricultural composition is characterized by a percolation distance in a range from 1 to 60 cm within a substrate selected from the group consisting of a soil, an area under cultivation and growth medium or any combination thereof.

17. A method for controlling a pest or reducing growth thereof, or for disinfecting said soil or growth medium, comprising providing an effective amount of the agricultural composition of claim 1; and contacting the agricultural composition with a substrate infested with said pest, thereby controlling or reducing growth of said pest.

18. The method of claim 17, wherein said method is controlling or reducing growth of said pest at a depth ranging from 1 to 60 cm within said substrate.

19. The method of claim 17, wherein said substrate is selected from the group consisting of: a soil, a plant, parts of the plant, area under cultivation and growth medium or any combination thereof.

20. (canceled)

21. The method of claim 17, wherein said pest is a pathogenic parasite, optionally wherein said pest is selected from the group consisting of: nematodes, fungi, microorganisms and weed.

22. (canceled)

23. The method of claim 22, wherein said (i) nematode is Meloidogyne javanica or (ii) wherein said fungus is selected from the group consisting of: Sclerotium rolfsii, Fusarium oxysporum f. sp. radicis-lycopersici (Forl), Aspergillus niger, Botrytis cinerea, Alternaria alternata, Rhizoctonia solani, Fusarium oxysporum f. sp. radicis-cucumerinum, Lasiodiplodia theobromas, Neoscytalidium dimidiatum, Talaromyces spp., Phoma tracheiphila, Colletotrichum spp., Verticillium spp., Pythium spp., Macrophomina phaseolina and Penicillium digitatum.

24. (canceled)

25. (canceled)
